(19) United States
(12) Patent Application Publication
(10) Pub. No.: US 2026/0206096 A1
(43) Pub. Date: Jul. 16, 2026

(54) BROADCAST CHANNEL FOR WIRELESS COMMUNICATIONS

(71) Applicant: Lenovo (United States) Inc., Morrisville, NC (US)

(72) Inventors: Hossein Bagheri, Dearborn Heights, MI (US); Karthikeyan Ganesan, Nauheim (DE); Vijay Nangia, Woodridge, IL (US)

(21) Appl. No.: 19/021,100

(22) Filed: Jan. 14, 2025

(51) Int. Cl. H04W 76/40; H04W 56/00

(52) U.S. Cl. CPC H04W 76/40; H04W 56/002

(57) ABSTRACT

Various aspects of the present disclosure relate to transmitting a synchronization signal block (SSB) associated with a cell, where the SSB spans a plurality of symbols and comprises at least a first set of symbols and a second set of symbols mutually exclusive to the first set of symbols; transmitting a broadcast channel within the first set of symbols; and transmitting a reference signal corresponding to the broadcast channel within the second set of symbols, where one or more symbol locations of the second set of symbols is based at least in part on an identifier of the cell.

### TECHNICAL FIELD

The present disclosure relates to wireless communications, and more specifically to broadcast channels for wide area communications, including low power wide area (LPWA) communications.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE for wireless communication is described. The UE may be configured to, capable of, or operable to receive a synchronization signal block (SSB) associated with a cell, wherein the SSB spans a plurality of symbols and comprises at least a first set of symbols and a second set of symbols mutually exclusive to the first set of symbols; determine one or more symbol locations of the second set of symbols is based at least in part on an identifier of the cell; decode a reference signal within the second set of symbols; and decode a broadcast channel within the first set of symbols based at least in part on the decoded reference signal.

A processor for wireless communication is described. The processor may be configured to, capable of, or operable to receive a SSB associated with a cell, wherein the SSB spans a plurality of symbols and comprises at least a first set of symbols and a second set of symbols mutually exclusive to the first set of symbols; determine one or more symbol locations of the second set of symbols is based at least in part on an identifier of the cell; decode a reference signal within the second set of symbols; and decode a broadcast channel within the first set of symbols based at least in part on the decoded reference signal.

A method performed or performable by a UE for wireless communication is described. The method may include receiving a SSB associated with a cell, wherein the SSB spans a plurality of symbols and comprises at least a first set of symbols and a second set of symbols mutually exclusive to the first set of symbols; determining one or more symbol locations of the second set of symbols is based at least in part on an identifier of the cell; decoding a reference signal within the second set of symbols; and decoding a broadcast channel within the first set of symbols based at least in part on the decoded reference signal.

A base station for wireless communication is described. The base station may be configured to, capable of, or operable to transmit a SSB associated with a cell, wherein the SSB spans a plurality of symbols and comprises at least a first set of symbols and a second set of symbols mutually exclusive to the first set of symbols; transmit a broadcast channel within the first set of symbols; and transmit a reference signal corresponding to the broadcast channel within the second set of symbols, wherein one or more symbol locations of the second set of symbols is based at least in part on an identifier of the cell.

A processor for wireless communication is described. The processor may be configured to, capable of, or operable to transmit a SSB associated with a cell, wherein the SSB spans a plurality of symbols and comprises at least a first set of symbols and a second set of symbols mutually exclusive to the first set of symbols; transmit a broadcast channel within the first set of symbols; and transmit a reference signal corresponding to the broadcast channel within the second set of symbols, wherein one or more symbol locations of the second set of symbols is based at least in part on an identifier of the cell.

A method performed or performable by a base station for wireless communication is described. The method may include transmitting a SSB associated with a cell, wherein the SSB spans a plurality of symbols and comprises at least a first set of symbols and a second set of symbols mutually exclusive to the first set of symbols; transmitting a broadcast channel within the first set of symbols; and transmitting a reference signal corresponding to the broadcast channel within the second set of symbols, wherein one or more symbol locations of the second set of symbols is based at least in part on an identifier of the cell.

### BRIEF DESCRIPTION OF THE DRAWINGS

FIG. 1 illustrates an example of a wireless communications system in accordance with aspects of the present disclosure.

FIG. 2 illustrates an example of an initial access procedure in accordance with aspects of the present disclosure.

FIG. 3 illustrates an example of a synchronization signal block (SSB) burst set comprising multiple SSB transmissions, in accordance with aspects of the present disclosure.

FIG. 4 illustrates an example of a transmission diagram, in accordance with aspects of the present disclosure.

FIG. 5 illustrates an example of a time-spread SSB structure for discrete Fourier transform spread orthogonal frequency division multiplexing (DFT-S-OFDM) in the downlink (DL) direction, in accordance with aspects of the present disclosure.

FIG. 6 illustrates an example of a time-spread SSB structure for DFT-S-OFDM in the DL direction, in accordance with aspects of the present disclosure.

FIG. 7 illustrates an example of a time-spread SSB structure for DFT-S-OFDM in the DL direction, in accordance with aspects of the present disclosure.

FIG. 8 illustrates an example of a time-spread SSB structure for DFT-S-OFDM in the DL direction, in accordance with aspects of the present disclosure.

FIG. 9 illustrates an example of a time-spread SSB structure for DFT-S-OFDM in the DL direction, in accordance with aspects of the present disclosure.

FIG. 10 illustrates an example of a time-spread SSB structure for DFT-S-OFDM in the DL direction, in accordance with aspects of the present disclosure.

FIG. 11 illustrates an example of a time-spread SSB structure for DFT-S-OFDM in the DL direction, in accordance with aspects of the present disclosure.

FIG. 12 illustrates an example of a time-spread SSB structure for DFT-S-OFDM in the DL direction, in accordance with aspects of the present disclosure.

FIG. 13 illustrates an example of a time-spread SSB structure for DFT-S-OFDM in the DL direction, in accordance with aspects of the present disclosure.

FIG. 14 illustrates an example of a time-spread SSB structure for DFT-S-OFDM in the DL direction, in accordance with aspects of the present disclosure.

FIG. 15 illustrates an example of a time-spread SSB structure for DFT-S-OFDM in the DL direction, in accordance with aspects of the present disclosure.

FIG. 16 illustrates an example of a time-spread SSB structure for DFT-S-OFDM in the DL direction, in accordance with aspects of the present disclosure.

FIG. 17 illustrates an example of a time-spread SSB structure for DFT-S-OFDM in the DL direction, in accordance with aspects of the present disclosure.

FIG. 18 illustrates an example of a time-spread SSB structure for DFT-S-OFDM in the DL direction, in accordance with aspects of the present disclosure.

FIG. 19 illustrates an example of a time-spread SSB structure for DFT-S-OFDM in the DL direction, in accordance with aspects of the present disclosure.

FIG. 20 illustrates an example of a time-spread SSB structure for DFT-S-OFDM in the DL direction, in accordance with aspects of the present disclosure.

FIG. 21 illustrates an example of a time-spread SSB structure for DFT-S-OFDM in the DL direction, in accordance with aspects of the present disclosure.

FIG. 22 illustrates an example of a time-spread SSB structure for DFT-S-OFDM in the DL direction, in accordance with aspects of the present disclosure.

FIG. 23 illustrates an example of a time-spread SSB structure for DFT-S-OFDM in the DL direction, in accordance with aspects of the present disclosure.

FIG. 24 illustrates an example of a time-spread SSB structure for DFT-S-OFDM in the DL direction, in accordance with aspects of the present disclosure.

FIG. 25 illustrates an example of a time-spread SSB structure for DFT-S-OFDM in the DL direction, in accordance with aspects of the present disclosure.

FIG. 26 illustrates an example of a time-spread SSB structure for DFT-S-OFDM in the DL direction, in accordance with aspects of the present disclosure.

FIG. 27 illustrates an example of a time-spread SSB structure for DFT-S-OFDM in the DL direction, in accordance with aspects of the present disclosure.

FIG. 28 illustrates an example of a time-spread SSB structure for DFT-S-OFDM in the DL direction, in accordance with aspects of the present disclosure.

FIG. 29 illustrates an example of a time-spread SSB structure for DFT-S-OFDM in the DL direction, in accordance with aspects of the present disclosure.

FIG. 30 illustrates an example of a time-spread SSB structure for DFT-S-OFDM in the DL direction, in accordance with aspects of the present disclosure.

FIG. 31 illustrates an example of a time-spread SSB structure for DFT-S-OFDM in the DL direction, in accordance with aspects of the present disclosure.

FIG. 32 illustrates an example of a time-spread SSB structure for DFT-S-OFDM in the DL direction, in accordance with aspects of the present disclosure.

FIG. 33 illustrates an example of a time-spread SSB structure for DFT-S-OFDM in the DL direction, in accordance with aspects of the present disclosure.

FIG. 34 illustrates an example of a time-spread SSB structure for DFT-S-OFDM in the DL direction, in accordance with aspects of the present disclosure.

FIG. 35 illustrates an example of a time-spread SSB structure for DFT-S-OFDM in the DL direction, in accordance with aspects of the present disclosure.

FIG. 36 illustrates an example of a time-spread SSB structure for DFT-S-OFDM in the DL direction, in accordance with aspects of the present disclosure.

FIG. 37 illustrates an example of a time-spread SSB structure for DFT-S-OFDM in the DL direction, in accordance with aspects of the present disclosure.

FIG. 38 illustrates an example of a time-spread SSB structure for DFT-S-OFDM in the DL direction, in accordance with aspects of the present disclosure.

FIG. 39 illustrates an example of a time-spread SSB structure with dynamic SSB length, in accordance with aspects of the present disclosure.

FIG. 40 illustrates an example of a time-spread SSB structure with dynamic SSB length, in accordance with aspects of the present disclosure.

FIG. 41 illustrates an example of a protocol stack, in accordance with aspects of the present disclosure.

FIG. 42 illustrates an example of a UE, in accordance with aspects of the present disclosure.

FIG. 43 illustrates an example of a processor, in accordance with aspects of the present disclosure.

FIG. 44 illustrates an example of a NE, in accordance with aspects of the present disclosure.

FIG. 45 illustrates a flowchart of a method performed by a UE, in accordance with aspects of the present disclosure.

FIG. 46 illustrates a flowchart of a method performed by a NE, in accordance with aspects of the present disclosure.

### DETAILED DESCRIPTION

Some wireless communication systems may support one or more energy saving techniques. In some examples, a UE and/or a NE (e.g., a base station) in these wireless communications systems can operate in one or more different modes that result in different power consumption by the UE and/or the NE including, but not limited to, an inactive mode, idle mode, and/or an active mode. In the inactive mode or the idle mode, the UE and/or the NE can refrain from communicating (e.g., transmitting and receiving) signaling, leading to power savings as components of the UE and/or the NE that perform the signaling or processing (e.g., monitoring, decoding, encoding, detecting, and the like) can be powered down and/or enter a reduced power consumption state. In the active mode, the UE and/or the NE can communicate signaling, leading to a relatively high power consumption when compared with the power saving mode due to the components that perform the signaling or processing during the active mode.

The next generation of wireless communication systems aims to increase energy efficiency at the NE (e.g., base station), and to provide extended coverage for some internet-of-things (IoT) device types (e.g., IoT type UEs). Some wireless communication systems use a cyclic prefix orthogonal frequency division multiplexing (CP-OFDM) waveform for downlink (DL) communications. However, energy savings can be achieved by using different waveforms for the DL communications that offer better peak-to-average power ratio (PAPR) properties compared to CP-OFDM, particularly in scenarios where low modulation orders and coding rates are applicable. Moreover, signaling efficiency can be improved by establishing a unified framework and common signaling for various device types in the next generation of wireless communication systems.

An IoT type of UE may operate as an LPWA device, also referred to as an “LPWA UE.” The power consumption of the related digital baseband processing for LPWA UEs scales with bandwidth, such devices may operate with limited bandwidth to maintain low power consumption. The limited bandwidth operation is suitable to support IoT communications, among other lower-power communication types. Because the same cell may support both LPWA UEs (i.e., IoT devices capable of communication only within a limited bandwidth, with a limited number of transmit/receive antennas, and/or requiring extended coverage) and non-LPWA UEs, cells may support a modified broadcast channel (e.g., physical broadcast channel (PBCH)) design (e.g., configuration) for initial access to a network.

Accordingly, aspects of the present disclosure relate to determining a configuration for a broadcast channel, for example, a PBCH configuration, as well as and resources and/or occasions (e.g., in a time domain) by both LPWA UEs and non-LPWA UEs in a cell containing both UE types. In some examples, the broadcast channel may be multiplexed in the time domain, to support energy-saving waveforms. In some implementations, the broadcast channel is a PBCH usable by a UE for initial access to a cell. In such implementations, the symbol locations of the PBCH contents may vary based on an identifier of the cell. For example, a demodulation reference signal (DMRS) associated with the PBCH (PBCH-DMRS) may be located in one of a plurality of candidate symbol locations based on the identifier of the cell. Thus, after determining the identifier of the cell from an SSB, a UE may determine the location of the PBCH-DMRS for the SSB.

In some implementations, to extend coverage for LPWA UEs, the broadcast channel may be spread in the time domain. To support both extended coverage for LPWA UEs and normal coverage for non-LPWA UEs, the broadcast channel may be split into two subchannels. In one implementation, a first broadcast subchannel may serve both the LPWA UEs and the non-LPWA UEs. In other words, the first broadcast subchannel may contain information needed by both LPWA UEs and the non-LPWA UEs for the initial access to a cell. In another implementation, a second broadcast subchannel may include information usable by the non-LPWA UEs and not needed by the LPWA UEs. As such, the LPWA UE would only need to decode the first broadcast subchannel, while the non-LPWA UEs would decode both the first and second broadcast subchannels. Beneficially, this provides power savings at the LPWA UEs as less decoding is required.

Additionally, while presented as distinct solutions, one or more of the solutions described herein may be implemented in combination with each other. Aspects of the present disclosure are described in the context of a wireless communications system.

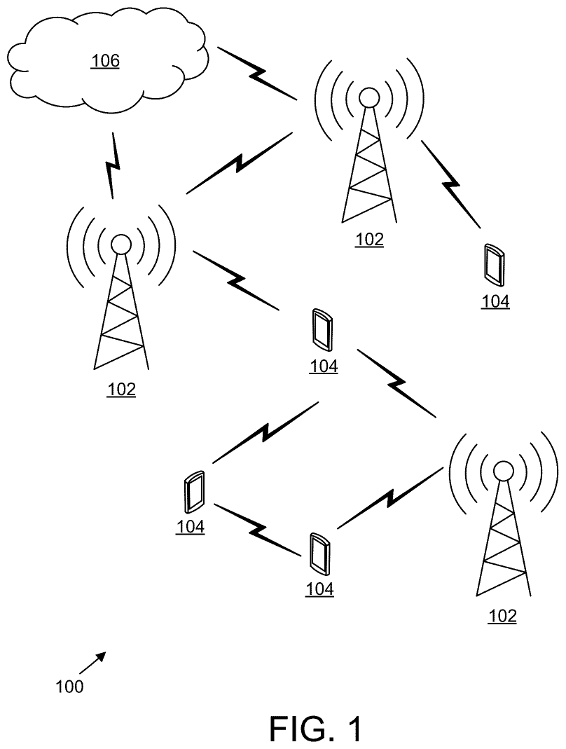

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

According to implementations, one or more of the NEs 102 and the UEs 104 are operable to implement various aspects of the techniques described with reference to the present disclosure.

In various implementations, the NE 102 may transmit a SSB transmission associated with a cell, where the SSB spans a plurality of symbols (e.g., OFDM symbols, or similar time-domain units) and comprises at least a first set of symbols and a second set of symbols mutually exclusive to the first set of symbols. Moreover, the NE 102 may transmit a broadcast channel (e.g., PBCH) within the first set of symbols and transmit a reference signal (e.g., DMRS) corresponding to the broadcast channel (e.g., PBCH) within the second set of symbols. Consequently, a respective UE 104 may receive the SSB transmission associated with the cell.

In some examples, a time-domain location of the second set of symbols (e.g., the DMRS) is based at least in part on an identifier of the cell. For example, the time-domain location may define a set of or more symbol locations. Accordingly, a respective UE 104 may determine the time-domain location of the second set of symbols is based at least in part on an identity of the cell. Further, the UE 104 may decode a DMRS within the second set of symbols and decode a PBCH within the first set of symbols based at least in part on the decoded DMRS.

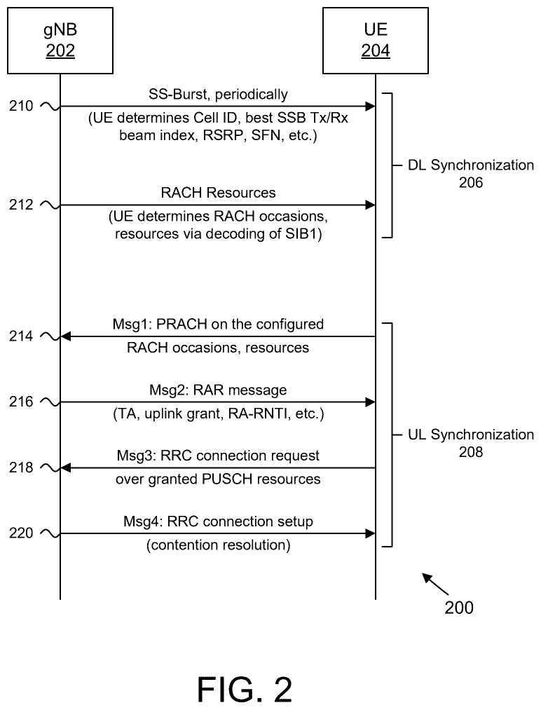

FIG. 2 illustrates an example of an initialization and initial access procedure 200 in accordance with aspects of the present disclosure. In 5G NR wireless communication systems, the UE 204 uses the initial access procedure to (re)synchronize itself with a serving network node (e.g., the gNB 202), (re)acquire the system information, and (re)establish a radio link. In some examples, the initialization and initial access procedure 200 occurs after the UE 204 powers on.

For initial access, the UE 204 (e.g., an embodiment of the UE 104) detects a candidate cell via performing DL synchronization procedure. For example, the gNB 202 (e.g., an embodiment of the NE 102) may transmit a synchronization signal/physical broadcast channel (SS/PBCH) transmission, also referred to as an SSB. The synchronization signal is a predefined sequence known to the UE 204 (or derivable using information already stored at the UE 204) and is in a predefined location in time relative to frame/subframe boundaries, etc.

The UE 204 tunes to a specific frequency and searches for (i.e., tries to detect) the SSB and uses the SSB to obtain DL timing information (e.g., symbol timing) for the DL synchronization. The UE 204 may also decode system information (SI) based on the SSB. Note that with beam-based communication, each DL beam may be associated with a respective SSB.

During the DL synchronization step 206, the gNB 202 transmits a SSB burst, e.g., periodically (see signaling 210). In beam-based communication, the UE 204 measures and then selects the transmit beam (Tx beam) and receive beam (Rx beam) pair indices associated with the best SSB, where each SSB consists of the primary synchronization signal (PSS), the secondary synchronization signal (SSS), and the physical broadcast channel (PBCH). In certain embodiments, the UE 204 uses the PSS to synchronize in the frequency domain and uses the SSS to synchronize in the time domain. Additionally, the UE 204 calculates the cell identity (cell-ID) using the PSS and SSS. In certain embodiments, the PBCH carries basic system information (e.g., the master information block (MIB)) needed for the UE 204 to begin communicating with the gNB 202. For example, if the cell broadcasting the SSB is barred to the UE 204, then the UE 204 may scan for another cell.

After acquiring synchronization (and cell-ID) and MIB (i.e., PBCH), the UE 204 determines (from the MIB) the location (i.e., in time and/or frequency) of the control resource set with index zero (CORESET #0). Then, the UE 204 searches the CORESET #0 to obtain system information block (SIB) type 1 (SIB1) information. The minimum number of resource blocks (RBs) for CORESET #0 in 5G NR is 24 RBs.

The gNB 202 indicates the random access channel (RACH) resources, e.g., by transmitting SIB1 (see signaling 212). The SIB1 provides network access parameters (including random access parameters, such as RACH resources) along with scheduling information about all other system information. The SIB1 is carried by a broadcast physical downlink shared channel (PDSCH) transmission scheduled by a physical downlink control channel (PDCCH) transmission sent in the CORESET #0. In some examples, the SIB1 may be transmitted with a periodicity of 160 ms and may have variable transmission repetition periodicity within 160 ms. In some implementations, the timing and repetition pattern of SIB1 is indicated by PDCCHs scheduling SIB1 within the 160 ms period.

In 5G NR, the PDCCH carries control channel information, including downlink control information (DCI). The DCI bits (e.g., after medium access control (MAC) sublayer and physical (PHY) layer procedures including: cyclic redundancy check (CRC) attachment, radio network temporary identity (RNTI) masking, interleaving, polar encoding, sub-block interleaving, rate-matching, scrambling, and quadrature phase shift keying (QPSK) modulation) are mapped to resource element groups (REGs), and 6 REGs are mapped to a control channel element (CCE); wherein a REG spans 1 RB in one symbol. In each REG, nine REs of the REG contain PDCCH payload, and the remaining three REs contain DMRS.

A UE performs blind detection/decoding of control channel candidates of a PDCCH monitoring occasion of a search space set; wherein each PDCCH candidate comprises one or multiple CCEs (also known as aggregation level (AL); with possible values of 1, 2, 4, 8, 16). A PDCCH with AL ‘L’ comprises ‘L’ contiguous CCEs (associated REGs can be in non-contiguous positions). The associated REGs belong to a control resource set (CORESET). As used herein, the CORESET refers to the time-frequency resources within a bandwidth part (BWP) where the PDCCH can be located. A cell may have multiple CORESETs. In some examples, each CORESET may be defined by several parameters, including the number of OFDM symbols, the frequency domain location, and the time domain allocation.

There are two types of CCE-to-REG mapping: interleaved and non-interleaved. In the case of interleaved mapping, each CCE is composed of one or more REG bundles which are distributed in the frequency domain in units of REG bundles. A REG bundle is a set of indivisible resources consisting of neighboring REGs. A REG bundle spans across all OFDM symbols for the given CORESET. For non-interleaved CCE-to-REG mapping, all CCEs of a PDCCH with AL ‘L’ are mapped in consecutive REG bundles of the CORESET.

The resources for the CORESET are configured by radio resource control (RRC) signaling except for CORESET 0. PDCCH can be precoded in a wideband manner or a narrowband manner. In wideband precoding, PDCCH DMRSs are transmitted in all contiguous REGs of a CORESET carrying the PDCCH using the same precoder. However, in narrow-band precoding, DMRS REs are transmitted only in the REG bundles actually used for the PDCCH transmission, and precoding is constant only within the REG bundle.

The CORESET #0 is a special CORESET which carries PDCCH/DCI for SIB1. The time-frequency resource of CORESET 0 is indicated by MIB which is carried by PBCH (as part of SSB). In 5G NR, CORESET 0 can have 24 or 48 RBs and 1-3 symbols in FR1.

After performing DL synchronization and acquiring essential SI, such as the MIB and the SIB1, and if the cell selection is successful, the UE 204 performs uplink (UL) synchronization and resource request by performing a random-access procedure, referred to as “RACH procedure,” and then transition to connected mode. The UE 204 determines RACH occasion (RO) resources, e.g., via decoding the SIB1.

As used herein, a RO refers to a time period (e.g., interval or scheduling window) during which the UE 204 is permitted to attempt to access the gNB 202 using a RACH procedure. Within a RO, there may be multiple physical random access channel (PRACH) resource occasions, depending on the system configuration. As used herein, a PRACH resource occasion refers to a specific set of time-frequency resources allocated for the UE to perform a PRACH transmission (i.e., transmit a PRACH preamble). For example, the PRACH resource occasion may correspond to specific resource blocks (RBs) and subframes within a RO.

During the UL synchronization step 208, the UE 204 first selects a RACH preamble from the configured preamble pool associated with the selected SSB Tx beam and transmits a PRACH message (Msg1 or MsgA) using the identified SSB Rx beam over one or more of the ROs associated with the selected SSB Tx beam index (see signaling 214).

Regarding random access, two types of RACH procedure are supported in a 3rd Generation Partnership Project (3GPP) wireless communication network: A) a 4-step random-access (RA) type initiated by the sending of a RACH message 1 (Msg1) and 2-step RA type with RACH message A (MsgA). Both types of RACH procedure support contention-based random access (CBRA) and contention-free random access (CFRA).

The UE 204 selects the RA type at the initiation of the RACH procedure, e.g., based on network configuration. In one example, when CFRA resources are not configured, a reference signal received power (RSRP) threshold is used by the UE 204 to select between 2-step RA type and 4-step RA type. In another example, when CFRA resources for 4-step RA type are configured, the UE 204 performs random access with 4-step RA type. In another example, when CFRA resources for 2-step RA type are configured, the UE 204 performs random access with 2-step RA type.

Note that the network does not configure CFRA resources for 4-step and 2-step RA types at the same time for a bandwidth part (BWP). Additionally, the CFRA with 2-step RA type is only supported for handover.

The Msg1 of the 4-step RA type consists of a preamble transmitted on a PRACH. After the Msg1 transmission, the UE 204 monitors for a response from the network within a configured window. For CFRA, a dedicated preamble for Msg1 transmission is assigned by the network and upon receiving a random access response (RAR) from the network, the UE 204 ends the random access procedure. For CBRA, upon reception of the RAR (see signaling 216), the UE 204 sends a RACH message 3 (Msg3) using a UL grant scheduled in the RAR and monitors for contention resolution (see signaling 218). If contention resolution is successful, the gNB 202 transmits a RACH message 4 (Msg4) for RRC connection setup (see signaling 220). However, if the contention resolution is not successful after Msg3 (re)transmission(s), then the UE 204 goes back to Msg1 transmission.

The MsgA of the 2-step RA type includes a preamble on the PRACH and a payload on a physical uplink shared channel (PUSCH). After the MsgA transmission, the UE 204 monitors for a response from the network within a configured window. For CFRA, a dedicated preamble and PUSCH resource are configured for MsgA transmission and upon receiving the network response, the UE 204 ends the random access procedure. For CBRA, if contention resolution is successful upon receiving the network response, then the UE 204 ends the random access procedure; however, if a fallback indication is received in a RACH message B (MsgB), the UE 204 performs Msg3 transmission using the UL grant scheduled in the fallback indication and monitors for contention resolution. If contention resolution is not successful after Msg3 (re)transmission(s), the UE 204 goes back to MsgA transmission. If the random access procedure with 2-step RA type is not completed after a number of MsgA transmissions, the UE 204 can be configured to switch to CBRA with 4-step RA type.

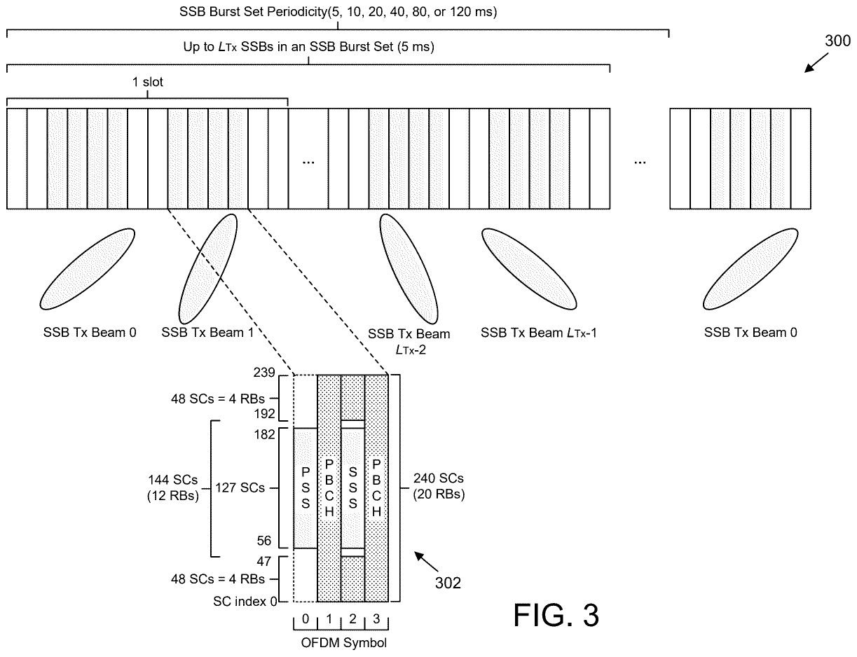

FIG. 3 illustrates an example of an SSB burst set 300 comprising multiple SSB transmissions, in accordance with aspects of the present disclosure. For example, the gNB 202 may transmit the SSB burst set 300 with a periodicity, such as 5 ms, 10 ms, 20 ms, 40 ms, 80 ms, or 160 ms. Alternatively, the periodicity may be expressed in terms of slots, i.e., {5, 10, 20, 40, 80, 160} slots. There are up to L_{TX} SSBs in the SSB burst set 300, each associated with a different one of the L_{TX} DL beams.

The SSB burst set 300 containing multiple SSB transmissions, each associated with different realization of a transmission attribute such as different transmission beams. In some examples, the SSB burst set 300 assists a UE (e.g., the UE 204) to select the best realization of the transmission attribute. In 5G NR, the NE (e.g., gNB 202) may perform beamforming for each SSB transmission, e.g., to increase the coverage of the SSB signaling.

In some instances, the SSB burst set 300 is contained within a 5 ms (i.e., half-frame) time window. The distance between two consecutive SSB transmissions is such that there is sufficient time for the UE 204 to receive different beams. In the example of FIG. 3, two SSB transmissions are performed in a slot. For 15 KHz SCS, the first SSB starts at symbol 2 and the second SSB starts at symbol 8, and this repeats two times for carrier frequencies less than or equal to 3 GHz, and may repeat four times for carrier frequencies between 3 GHz and 6 GHz.

A respective SSB transmission 302 (also referred to as a SS/PBCH transmission) includes the PSS, the SSS, and the PBCH. In the depicted embodiment, the SSB transmission duration is 4 OFDM symbols in the time domain, with the PSS and SSS each transmitted over 1 OFDM symbol, and the PBCH is transmitted over 3 OFDM symbols. As depicted, the PBCH and the SSS are multiplexed in the third symbol.

In 5G NR, the SSB transmission 302 spans 240 subcarriers, e.g., 20 resource block (RBs), in the frequency domain. The PSS and SSS span 127 subcarriers at the center of the SSB transmission 302. In the second and fourth OFDM symbols, the PBCH spans 240 subcarriers, while in the third OFDM symbol, the PBCH covers the 48 lowest subcarriers and the 48 highest subcarriers of the SSB transmission 302.

In 5G NR, the RB typically spans 12 subcarriers, and the bandwidth of the RB depends on the SCS used in the 5G NR system. For example, for 15 kHz SCS, the bandwidth of one RB is 180 kHz, while for 30 kHz SCS, the bandwidth of one RB is 360 kHz. Similarly, for 60 kHz SCS, the bandwidth of one RB is 720 kHz, while for 120 kHz SCS, the bandwidth of one RB is 1.44 MHz.

The duration of an RB in time is one slot, which may be composed of, e.g., 14 OFDM symbols in the time domain. In 5G NR, the time duration of an RB is based on the slot duration, which may vary according to the numerology and SCS used. For example, for 15 kHz SCS, the time duration of one RB (i.e., slot duration) is 1 ms, while for 30 kHz SCS, the time duration of one RB (slot duration) is 0.5 ms. Similarly, for 60 kHz SCS, the time duration of one RB (i.e., slot duration) is 0.25 ms, while for 120 kHz SCS, the time duration of one RB (slot duration) is 0.125 ms.

For 5G NR, the starting symbols and number of SSB blocks as function of system carrier frequency and SCS are defined in 3GPP technical specification (TS) 38.213.

Currently in 5G NR, PBCH payload is at most 32 bits and are appended by 24 bits CRC. The polar encoded stream would have 512 bits, and after rate matching it ends up having 864 bits. Using QPSK, 432 resource elements (REs) are needed. Further, the demodulation reference signal (DMRS) occupies 144 additional REs, leading to 144×4 REs for the PBCH transmission. Note that an RE in 5G NR is a combination of one subcarrier in the frequency domain and one OFDM symbol in the time domain.

Wireless networks employing 5G NR support multi-carrier based waveform. In NR release 15 (Rel-15), a multi-carrier based waveform (e.g., CP-OFDM) has been adopted for the DL direction and for the UL direction. However, CP-OFDM performance degrades at high frequencies (e.g., beyond 52.6 GHz) due to its sensitivity to phase noise and its high PAPR that limits the cell coverage and edge-of-cell performance, and also results in higher power consumption.

5G NR supports DFT-S-OFDM, which is a hybrid waveform combining single-carrier and multi-carrier aspects, wherein data symbols are pre-processed with a discrete Fourier transform (DFT) before OFDM modulation, thus spreading the signal symbols over multiple subcarriers. The resulting waveform has been used in 5G NR UL. Compared to the CP-OFDM waveform that is used both in UL and DL directions of 5G NR systems, the benefits of the DFT-S-OFDM waveform include: robustness to interference and fading, reduction of PAPR, and enhancing security due to spreading of the signal.

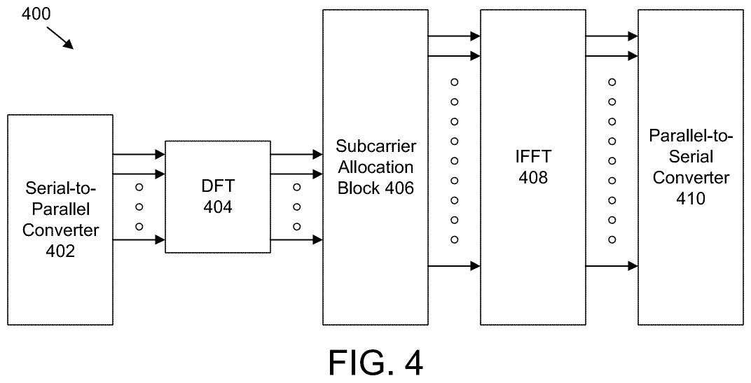

FIG. 4 illustrates an example of a transmitter design 400 for DFT-S-OFDM transmission, in accordance with aspects of the present disclosure. In some examples, the transmitter design 400 implements or is implemented by aspects of the wireless communications system 100. For example, the transmitter design 400 can be implemented by a UE and a NE, which may be examples of a UE 104 and a NE 102, e.g., as described with reference to FIG. 1.

As depicted, the data symbols (e.g., the SSB containing PSS, SSS, PBCH payload, and PBCH-DMRS) are converted to parallel data (e.g., via serial-to-parallel converter 402) and a DFT 404 with a configured size (e.g., based on the number of data symbols) is applied to the parallel output. A subcarrier allocation block 406 maps the DFT output sequence to resource elements (REs) for generating the OFDM signal, e.g., using k-point mapping where the k-points specify indices of the OFDM subcarriers in the frequency domain.

After the subcarrier allocation, an inverse fast Fourier transform (IFFT) 408 is applied to convert the frequency domain data into the time domain and the IFFT output is converted to parallel data, e.g., via parallel-to-serial converter 410 for transmission via a radio channel. While not shown in FIG. 4 it is assumed that the receiving node (e.g., NE 102 or UE 104) contains a complementary receiver which will perform the inverse operation of the transmitter design 400 (i.e., to decode the data symbols from the DFT-S-OFDM transmission.

Certain wireless communication systems may support UEs with different bandwidth capabilities, including LPWA UEs (also referred to as bandwidth limited UEs (BL-UEs) or IoT type UEs) and non-LPWA UEs (also referred to as wideband UEs (WB-UEs) or enhanced mobile broadband (eMBB) UEs).

To improve network energy savings, the present disclosure describes a broadcast channel design for cells serving low power wide area (LPWA) IoT communications. In some examples, the broadcast channel (e.g., PBCH) is transmitted using a DFT-S-OFDM (or similar) waveform. To reduce PAPR, such waveform requires signals transmitted via gNB in a time instance, such that the signals are not multiplexed in the frequency domain. As such, the legacy SS/PBCH structure shown in FIG. 3 cannot be used as the SSS and PBCH are multiplexed in the legacy structure.

Accordingly, the broadcast channel design may include different arrangements for PSS, SSS, PBCH, and PBCH-DMRS, where these transmissions are time-domain multiplexed (TDM'd). In some examples, to improve DMRS detection performance, the time index of the PBCH-DMRS(s) within the SSB are based on the cell identifier (e.g., cell-ID).

To provide an extended coverage for a LPWA-type device (i.e., LPWA UE) and also provide a normal coverage for a non-LPWA type device (i.e., non-LPWA UE) at least for PBCH operation using the same SSB, the PBCH may be split into two separate channels (or sets of symbols) with different code-rates and payload sizes for each channel. Aspects of the present disclosure also describe different SSB structures encompassing the two PBCH types along with mechanisms enabling decoding of such PBCHs. While the present disclosure describes two device types, in other implementations additional device types are covered, wherein the device types supporting enhanced coverage implement the LPWA UE behaviors as described herein.

In the following descriptions, it is assumed that both the LPWA UEs and the non-LPWA UEs acquire synchronization using the same synchronization signals (e.g., all device types use the same PSS and SSS). It is also assumed that both the LPWA UEs and the non-LPWA UEs decode at least a portion of the same PBCH. As described in further detail below, in some implementations the PBCH payload may be split into multiple portions where certain device types do not decode all parts of the PBCH.

The SSB structure needs to be spread more in time compared to that of the SSB structure in 5G to provide similar coverage as 5G or enhanced coverage for coverage-extended devices such as LPWA device types. Due to DFT-S-OFDM nature of signals, PBCH and its DMRS (referred to as PBCH-DMRS) are TDM'd within the SSB structure. Beneficially, by spreading the SSB in the time domain, certain device types, such as the LPWA UEs are able to operate on smaller bandwidth, as compared to the legacy SSB structure.

According to aspects of a first solution, the time-spread SSB structure may support various arrangements of the PSS, SSS, PBCH, and PBCH-DMRS symbols, in accordance with aspects of the present disclosure. It is assumed that an SSB component (e.g., PSS, SSS, PBCH, or PBCH-DMRS) may occupy more than one symbol, but that each symbol of the time-spread SSB is occupied by only one of PSS, SSS, PBCH, and PBCH-DMRS.

For representation, PSS, SSS, PBCH, and PBCH-DMRS are referred to as P, S, B, and D, respectively. In an example implementation, an SSB with 7 symbols defined by {P, P, B, S, S, D, B} shows an SSB having two PSS symbols in the beginning, followed by one PBCH symbol, two subsequent SSS symbols, followed by 1 PBCH-DMRS symbol, and one PBCH symbol at the end.

In the following, it is assumed that PSS/SSS, and PBCH occupy similar number of REs in each symbol. Unless otherwise stated, it is assumed that the PSS and SSS in the time-spread SSB are substantially the same as those used in 5G NR. It is further assumed (unless otherwise stated) that an LPWA UE can operate in a 12 RB bandwidth for at least SSB detection purposes.

In some embodiments, for case of high Doppler (e.g., when the mobility speed is high), the time-spread SSB structure may locate the PSS and the SSS close to each other in the time domain, so that approximately the same channel conditions are experienced by both the PSS and the SSS, as the SSS is detected based on the detected PSS. Accordingly, in some embodiments the PSS is located in the first symbol of the time-spread SSB structure, and the SSS is located in the second or third symbol of the time-spread SSB structure. In such embodiments, the fourth and subsequent symbols of the time-spread SSB structure are occupied by the PBCH-DMRS and the PBCH payload symbols.

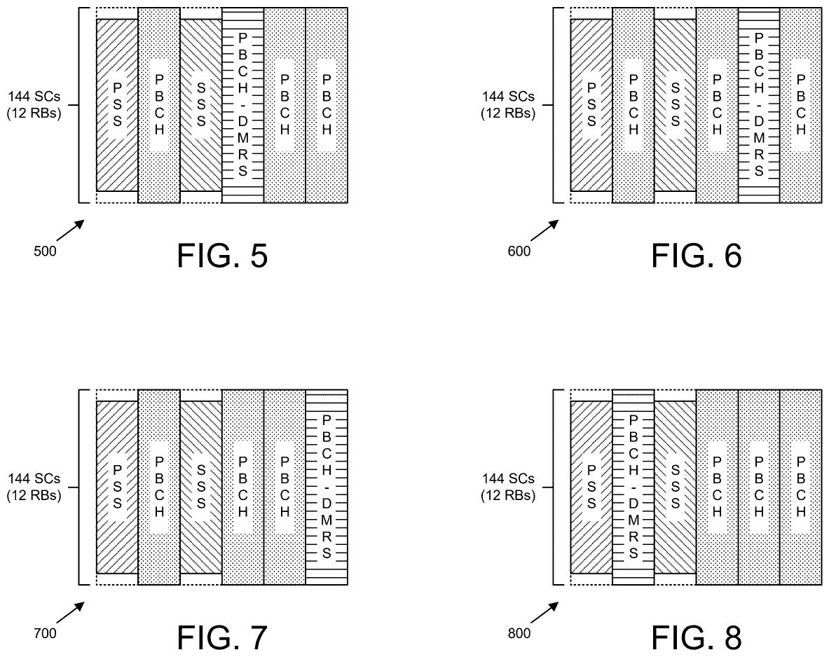

FIGS. 5-8 show examples of DMRS distribution within an SSB for situations where there is one PSS symbol, one SSS symbol, three PBCH payload symbols, and one PBCH-DMRS symbol. In the depicted examples, the PSS is located in the first symbol, the SSS is located in the third symbol, and the PBCH region comprises the second, fourth, fifth, and sixth symbols; however, other arrangements are within the scope of the present disclosure.

FIG. 5 illustrates an example of a time-spread SSB structure 500 for a wireless network using DFT-S-OFDM in the DL direction, in accordance with aspects of the present disclosure. In the example of FIG. 5, the time-spread SSB structure 500 has the same (or substantially similar) payload as the PBCH supported in 5G NR. Based on the above assumptions, the time-spread SSB structure 500 achieves the same PBCH coverage as currently supported in 5G NR. In some implementations of the time-spread SSB structure 500, the PBCH-DMRS symbol is a fixed symbol irrespective of physical cell-ID (e.g., the PBCH-DMRS is located right after the SSS).

In other implementations, the location of the PBCH-DMRS symbol may be based on the cell-ID, wherein the UE determines the PBCH-DMRS symbol location after PSS/SSS detection, as further described with reference to FIGS. 5-8. In the example of FIG. 5, the PBCH-DMRS is located in the fourth OFDM symbol, e.g., for

$$\begin{matrix}{N}_{ID}^{cell} = 0 , \\ where {N}_{ID}^{cell} ∈ \{ 0 , 1 , 2 , 3 \} , or {N}_{ID}^{cell} mod 4 = 0 , wherein {N}_{ID}^{cell}\end{matrix}$$

is related to the cell-ID (e.g.,

$${N}_{ID}^{cell}$$

is the cell-ID) of the cell associated with the SSB transmission.

FIG. 6 illustrates an example of a time-spread SSB structure 600 for a wireless network using DFT-S-OFDM in the DL direction, in accordance with aspects of the present disclosure. In the example of FIG. 6, the time-spread SSB structure 600 has the same payload and components as the time-spread SSB structure 500; however, the PBCH-DMRS is located in the fifth OFDM symbol, e.g., for

$$\begin{matrix}{N}_{ID}^{cell} = 1 , where {N}_{ID}^{cell} ∈ \\ \{ 0 , 1 , 2 , 3 \} , or {N}_{ID}^{cell} mod 4 = 1.\end{matrix}$$

FIG. 7 illustrates an example of a time-spread SSB structure 700 for a wireless network using DFT-S-OFDM in the DL direction, in accordance with aspects of the present disclosure. In the example of FIG. 7, the time-spread SSB structure 700 has the same payload and components as the time-spread SSB structure 500; however, the PBCH-DMRS is located in the sixth OFDM symbol, e.g.,

$$\begin{matrix}{N}_{ID}^{cell} = 2 , where {N}_{ID}^{cell} ∈ \\ \{ 0 , 1 , 2 , 3 \} , or {N}_{ID}^{cell} mod 4 = 2.\end{matrix}$$

FIG. 8 illustrates an example of a time-spread SSB structure 800 for a wireless network using DFT-S-OFDM in the DL direction, in accordance with aspects of the present disclosure. In the example of FIG. 8, the time-spread SSB structure 800 has the same payload and components as the time-spread SSB structure 500; however, the PBCH-DMRS is located in the second OFDM symbol, e.g., for

$$\begin{matrix}{N}_{ID}^{cell} = 3 , where {N}_{ID}^{cell} ∈ \\ \{ 0 , 1 , 2 , 3 \} , or {N}_{ID}^{cell} mod 4 = 3.\end{matrix}$$

In still other implementations, the time location of PBCH-DMRS symbol is determined based on a detected partial cell-ID, such as the PSS sequence identifier (ID),

$${N}_{ID}^{( 2 )} ,$$

wherein the UE determines the PBCH-DMRS symbol location after PSS detection, as further described with reference to FIGS. 5-7. In some examples,

$${N}_{ID}^{( 2 )} ∈ \{ 0 , 1 , 2 \} ,$$

and may be related to cell-ID, such as

$${N}_{ID}^{( 2 )} = {N}_{ID}^{cell} mod 3.$$

In the example of FIG. 5, the PBCH-DMRS is located in the fourth OFDM symbol, e.g., for

$${N}_{ID}^{( 2 )} = 0.$$

In the example of FIG. 6, the PBCH-DMRS is located in the fifth OFDM symbol, e.g., for

$${N}_{ID}^{( 2 )} = 1.$$

In the example of FIG. 7, the PBCH-DMRS is located in the sixth OFDM symbol, e.g., for

$${N}_{ID}^{( 2 )} = 2.$$

According to aspects of a second solution, to achieve an extended coverage (e.g., compared to what has been achievable in 5G NR for eMBB devices) the time-spread SSB may be expanded to occupy at least one extra symbol. The following examples illustrate the number of symbols for each signal/channel (other combinations are not precluded):

In a first example, there is 1 symbol for PSS, 1 symbol for SSS, 3 symbols for PBCH, and 2 symbols for PBCH-DMRS. In this example, the time-spread SSB occupies 7 OFDM symbols in the time domain.

In a second example, there is 1 symbol for PSS, 1 symbol for SSS, 4 symbols for PBCH, and 1 symbol for PBCH-DMRS. In this example, the time-spread SSB occupies 7 OFDM symbols in the time domain.

In a third example, there is 1 symbol for PSS, 1 symbol for SSS, 4 symbols for PBCH, and 2 symbols for PBCH-DMRS. In this example, the time-spread SSB occupies 8 OFDM symbols in the time domain.

In a fourth example, there are 2 symbols for PSS, 2 symbols for SSS, 3 symbols for PBCH, and 2 symbols for PBCH-DMRS. In this example, the time-spread SSB occupies 9 OFDM symbols in the time domain.

In a fifth example, there are 2 symbols for PSS, 2 symbols for SSS, 4 symbols for PBCH, and 2 symbols for PBCH-DMRS. In this example, the time-spread SSB occupies 10 OFDM symbols in the time domain.

In a sixth example, there are 2 symbols for PSS, 2 symbols for SSS, 3 symbols for PBCH, and 1 symbol for PBCH-DMRS. In this example, the time-spread SSB occupies 8 OFDM symbols in the time domain.

In a seventh example, there are 2 symbols for PSS, 2 symbols for SSS, 4 symbols for PBCH, and 1 symbol for PBCH-DMRS. In this example, the time-spread SSB occupies 9 OFDM symbols in the time domain.

In the case of two PBCH-DMRS symbols for the SSB, the location of the two PBCH-DMRS can be dependent on the cell-ID (or PSS sequence ID). As can be seen from the examples shown below (e.g., FIG. 8), for some of the cell-IDs, their DMRS symbols are not orthogonal to DMRS symbols of other cell-IDs. To have a balanced performance, the SSB structure can be determined not only based on the physical cell ID but also based on the occurrence time (e.g., half-frame or frame in which the SSB belongs to). Such a technique requires hypothesis testing over multiple hypotheses (each associated with an SSB structure with particular DMRS locations) as the device does not know the time notion (frame or half frame) prior to the decoding of PBCH/PBCH-DMRS. Unless such information is provided by SSS (or PSS or combination of both).

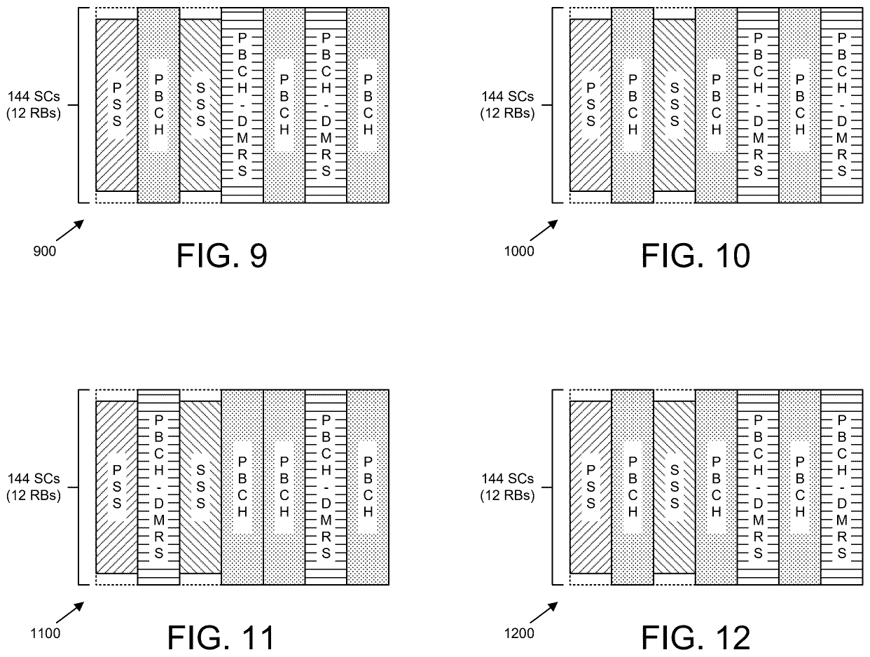

FIGS. 9-12 show examples of DMRS distribution within an SSB for situations where there is one PSS symbol, one SSS symbol, three PBCH payload symbols, and two PBCH-DMRS symbols. In the depicted examples, the PSS is located in the first symbol, the SSS is located in the third symbol, and the PBCH region comprises the second, fourth, fifth, sixth, and seventh symbols; however, other arrangements are within the scope of the present disclosure.

FIG. 9 illustrates an example of a time-spread SSB structure 900 for a wireless network using DFT-S-OFDM in the DL direction, in accordance with aspects of the present disclosure. In the example of FIG. 9, the time-spread SSB structure 900 has extended coverage as currently supported in 5G NR due to the additional symbol, which carries a PBCH-DMRS in the depicted example. In some implementations of the time-spread SSB structure 900, the PBCH-DMRS symbol locations are fixed irrespective of physical cell-ID (e.g., the first PBCH-DMRS is located right after the SSS, with a one symbol gap between the two PBCH-DMRS).

In other implementations, the locations of the PBCH-DMRS symbols may be based on the cell-ID, wherein the UE determines the PBCH-DMRS symbol location after PSS/SSS detection, as further described with reference to FIGS. 9-12. In the example of FIG. 9, the PBCH-DMRS are located in the fourth and sixth OFDM symbols, e.g., for

$${N}_{ID}^{cell} = 0 , where {N}_{ID}^{cell} ∈ \{ 0 , 1 , 2 , 3 \} , or {N}_{ID}^{cell} mod 4 = 0.$$

FIG. 10 illustrates an example of a time-spread SSB structure 1000 for a wireless network using DFT-S-OFDM in the DL direction, in accordance with aspects of the present disclosure. In the example of FIG. 10, the time-spread SSB structure 1000 has the same payload and components as the time-spread SSB structure 900; however, the PBCH-DMRS are located in the fifth and seventh OFDM symbols, e.g., for

$$\begin{matrix}{N}_{ID}^{cell} = 1 , \\ where {N}_{ID}^{cell} ∈ \{ 0 , 1 , 2 , 3 \} , or {N}_{ID}^{cell} mod 4 = 1.\end{matrix}$$

FIG. 11 illustrates an example of a time-spread SSB structure 1100 for a wireless network using DFT-S-OFDM in the DL direction, in accordance with aspects of the present disclosure. In the example of FIG. 11, the time-spread SSB structure 1100 has the same payload and components as the time-spread SSB structure 900; however, the PBCH-DMRS are located in the second and sixth OFDM symbols, e.g., for

$$\begin{matrix}{N}_{ID}^{cell} = 2 , \\ where {N}_{ID}^{cell} ∈ \{ 0 , 1 , 2 , 3 \} , or {N}_{ID}^{cell} mod 4 = 2.\end{matrix}$$

FIG. 12 illustrates an example of a time-spread SSB structure 1200 for a wireless network using DFT-S-OFDM in the DL direction, in accordance with aspects of the present disclosure. In the example of FIG. 12, the time-spread SSB structure 1200 has the same payload and components as the time-spread SSB structure 900; however, the PBCH-DMRS are located in the fourth and seventh OFDM symbols, e.g., for

$$\begin{matrix}{N}_{ID}^{cell} = 3 , \\ where {N}_{ID}^{cell} ∈ \{ 0 , 1 , 2 , 3 \} , or {N}_{ID}^{cell} mod 4 = 3.\end{matrix}$$

Note that DMRS symbols are orthogonal for

$${N}_{ID}^{cell} = 0 , 1 and {N}_{ID}^{cell} = 2 , 3.$$

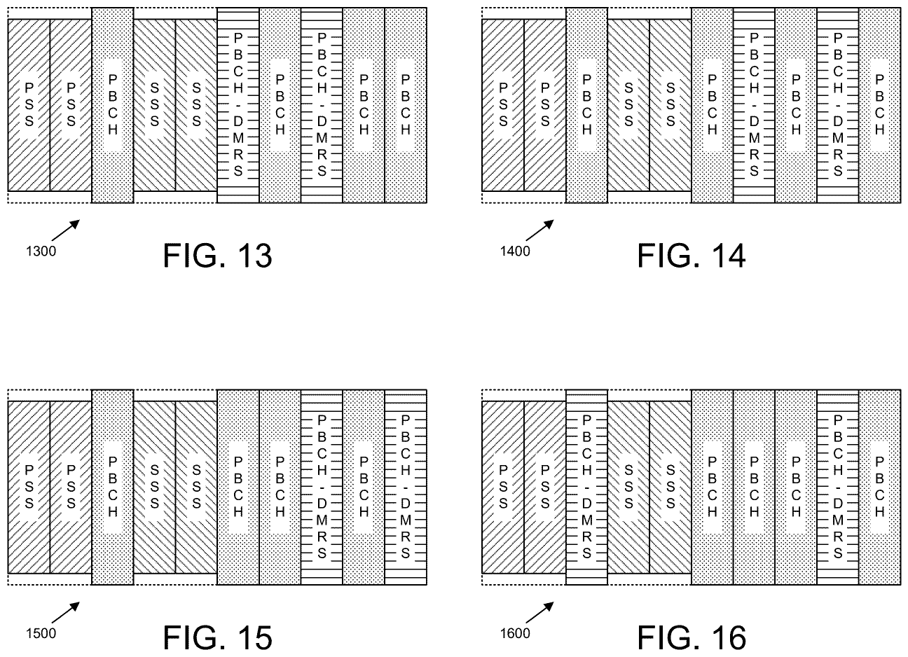

FIGS. 13-16 show examples of DMRS distribution within an SSB for situations where there are two PSS symbols, two SSS symbols, four PBCH payload symbols, and two PBCH-DMRS symbols. In the depicted examples, the PSS is located in the first and second symbols, the SSS is located in the fourth and fifth symbols, and the PBCH region comprises the third, sixth, seventh, eighth, ninth, and tenth symbols; however, other arrangements are within the scope of the present disclosure. In most cases, the gap between the two PBCH-DMRS symbols is one symbol.

FIG. 13 illustrates an example of a time-spread SSB structure 1300 for a wireless network using DFT-S-OFDM in the DL direction, in accordance with aspects of the present disclosure. In the example of FIG. 13, the time-spread SSB structure 1300 has extended coverage as currently supported in 5G NR due to the presence of additional symbols. In some implementations of the time-spread SSB structure 1300, the PBCH-DMRS symbol locations are fixed irrespective of physical cell-ID (e.g., the first PBCH-DMRS is located right after the SSS).

In other implementations, the locations of the PBCH-DMRS symbols may be based on the cell-ID, wherein the UE determines the PBCH-DMRS symbol location after PSS/SSS detection, as further described with reference to FIGS. 13-16. In the example of FIG. 13, the PBCH-DMRS are located in the sixth and eighth OFDM symbols, e.g., for

$${N}_{ID}^{cell} = 0 , where {N}_{ID}^{cell} ∈ \{ 0 , 1 , 2 , 3 \} , or {N}_{ID}^{cell} mod 4 = 0.$$

FIG. 14 illustrates an example of a time-spread SSB structure 1400 for a wireless network using DFT-S-OFDM in the DL direction, in accordance with aspects of the present disclosure. In the example of FIG. 14, the time-spread SSB structure 1400 has the same payload and components as the time-spread SSB structure 1300; however, the PBCH-DMRS are located in the seventh and ninth OFDM symbols, e.g., for

$${N}_{I D}^{c e l l} = 1 , where {N}_{I D}^{c e l l} ∈ \{ 0 , 1 , 2 , 3 \} , or {N}_{I D}^{c e l l} mod 4 = 1 .$$

FIG. 15 illustrates an example of a time-spread SSB structure 1500 for a wireless network using DFT-S-OFDM in the DL direction, in accordance with aspects of the present disclosure. In the example of FIG. 15, the time-spread SSB structure 1500 has the same payload and components as the time-spread SSB structure 1300; however, the PBCH-DMRS are located in the eighth and tenth OFDM symbols, e.g., for

$${N}_{I D}^{c e l l} = 2 , where {N}_{I D}^{c e l l} ∈ \{ 0 , 1 , 2 , 3 \} , or {N}_{I D}^{c e l l} mod 4 = 2.$$

FIG. 16 illustrates an example of a time-spread SSB structure 1600 for a wireless network using DFT-S-OFDM in the DL direction, in accordance with aspects of the present disclosure. In the example of FIG. 16, the time-spread SSB structure 1600 has the same payload and components as the time-spread SSB structure 1300; however, the PBCH-DMRS are located in the third and ninth OFDM symbols, e.g., for

$${N}_{I D}^{c e l l} = 3 , where {N}_{I D}^{c e l l} ∈ \{ 0 , 1 , 2 , 3 \} , or {N}_{I D}^{c e l l} mod 4 = 3.$$

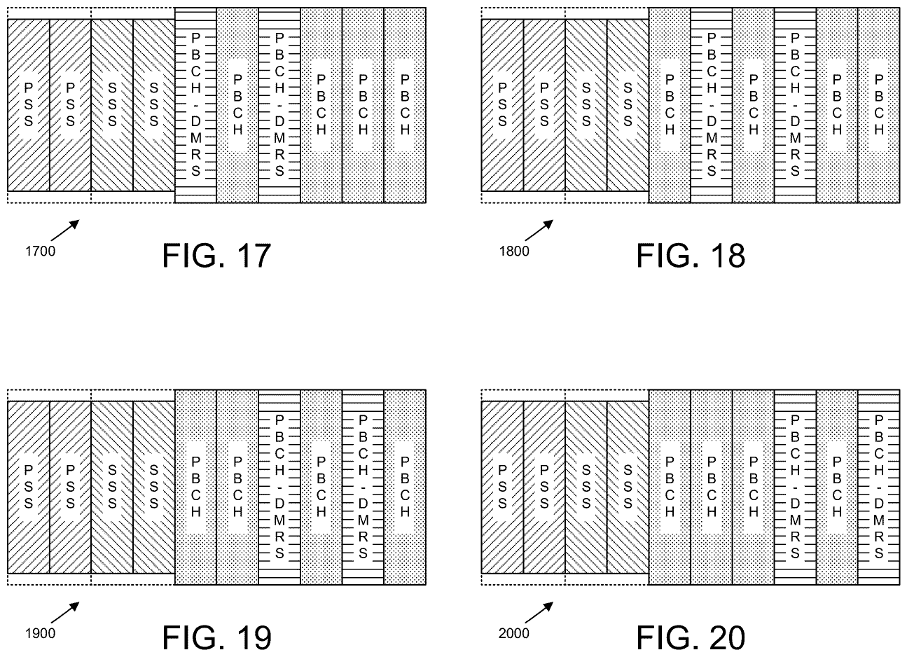

FIGS. 17-20 show examples of DMRS distribution within an SSB for situations where there are two PSS symbols, two SSS symbols, four PBCH payload symbols, and two PBCH-DMRS symbols. In the depicted examples, the PSS is located in the first and second symbols, the SSS is located in the third and fourth symbols, and the PBCH region comprises the fifth, sixth, seventh, eighth, ninth, and tenth symbols; however, other arrangements are within the scope of the present disclosure. In most cases, the gap between the two PBCH-DMRS symbols is one symbol.

FIG. 17 illustrates an example of a time-spread SSB structure 1700 for a wireless network using DFT-S-OFDM in the DL direction, in accordance with aspects of the present disclosure. In the example of FIG. 17, the time-spread SSB structure 1700 has extended coverage as currently supported in 5G NR due to the presence of additional symbols. In some implementations of the time-spread SSB structure 1700, the PBCH-DMRS symbol locations are fixed irrespective of physical cell-ID (e.g., the first PBCH-DMRS is located right after the SSS).

In other implementations, the locations of the PBCH-DMRS symbols may be based on the cell-ID, wherein the UE determines the PBCH-DMRS symbol location after PSS/SSS detection, as further described with reference to FIGS. 17-20. In the example of FIG. 17, the PBCH-DMRS are located in the fifth and seventh OFDM symbols, e.g., for

$${N}_{I D}^{c e l l} = 0 , where {N}_{I D}^{c e l l} ∈ \{ 0 , 1 , 2 , 3 \} , or {N}_{I D}^{c e l l} mod 4 = 0.$$

FIG. 18 illustrates an example of a time-spread SSB structure 1800 for a wireless network using DFT-S-OFDM in the DL direction, in accordance with aspects of the present disclosure. In the example of FIG. 18, the time-spread SSB structure 1800 has the same payload and components as the time-spread SSB structure 1700; however, the PBCH-DMRS are located in the sixth and eighth OFDM symbols, e.g., for

$${N}_{I D}^{c e l l} = 1 , where {N}_{I D}^{c e l l} ∈ \{ 0 , 1 , 2 , 3 \} , or {N}_{I D}^{c e l l} mod 4 = 1.$$

FIG. 19 illustrates an example of a time-spread SSB structure 1900 for a wireless network using DFT-S-OFDM in the DL direction, in accordance with aspects of the present disclosure. In the example of FIG. 19, the time-spread SSB structure 1900 has the same payload and components as the time-spread SSB structure 1700; however, the PBCH-DMRS are located in the seventh and ninth OFDM symbols, e.g., for

$${N}_{I D}^{c e l l} = 2 , where {N}_{I D}^{c e l l} ∈ \{ 0 , 1 , 2 , 3 \} , or {N}_{I D}^{c e l l} mod 4 = 2.$$

FIG. 20 illustrates an example of a time-spread SSB structure 2000 for a wireless network using DFT-S-OFDM in the DL direction, in accordance with aspects of the present disclosure. In the example of FIG. 20, the time-spread SSB structure 2000 has the same payload and components as the time-spread SSB structure 1700; however, the PBCH-DMRS are located in the eighth and tenth OFDM symbols, e.g., for

$${N}_{I D}^{c e l l} = 3 , where {N}_{I D}^{c e l l} ∈ \{ 0 , 1 , 2 , 3 \} , or {N}_{I D}^{c e l l} mod 4 = 3.$$

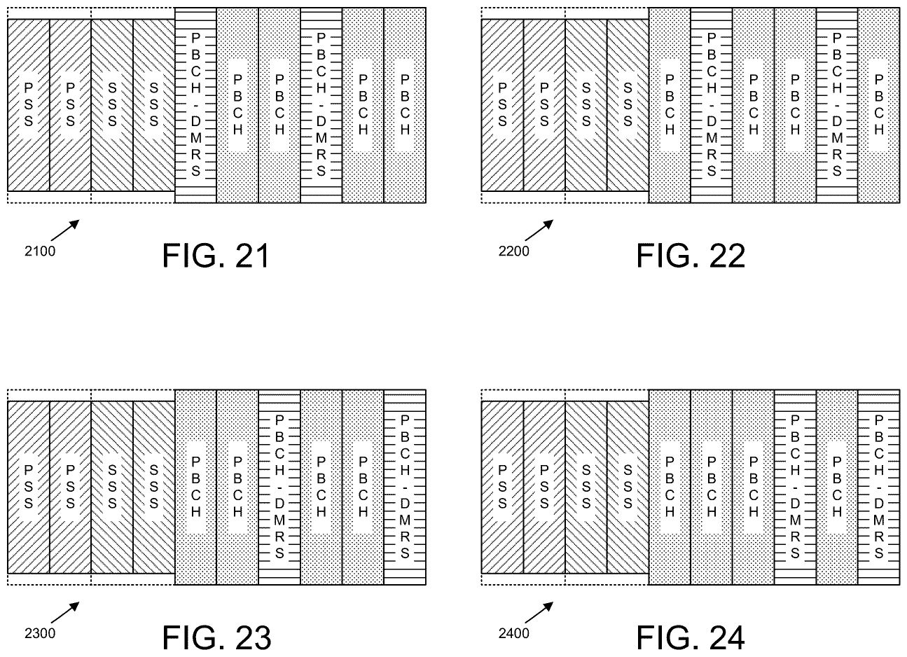

FIGS. 21-24 show examples of DMRS distribution within an SSB for situations where there are two PSS symbols, two SSS symbols, four PBCH payload symbols, and two PBCH-DMRS symbols. In the depicted examples, the PSS is located in the first and second symbols, the SSS is located in the third and fourth symbols, and the PBCH region comprises the fifth, sixth, seventh, eighth, ninth, and tenth symbols; however, other arrangements are within the scope of the present disclosure.

In the examples of FIGS. 21-24, the PBCH-DMRS symbols are distributed as uniformly as possible within the PBCH region. The PBCH-DMRS symbols corresponding to three cells

$$( {N}_{ID}^{c e l l} = 0 , 1 , 2 )$$

are orthogonal to each other and the fourth cell has overlap with 1 symbol of two cells. To balance the performance, the PBCH-DMRS locations may also be dependent on the half-frame, frame, etc. For example, in the next SSB repetition, the cell-ID mapping may be shifted, e.g., where the arrangement shown in FIG. 21 may correspond to

$${N}_{ID}^{c e l l} = 3 ,$$

the arrangement shown in FIG. 22 may correspond to

$${N}_{ID}^{c e l l} = 0 ,$$

etc.

FIG. 21 illustrates an example of a time-spread SSB structure 2100 for a wireless network using DFT-S-OFDM in the DL direction, in accordance with aspects of the present disclosure. In the example of FIG. 21, the time-spread SSB structure 2100 has extended coverage as currently supported in 5G NR due to the presence of additional symbols. In some implementations of the time-spread SSB structure 2100, the PBCH-DMRS symbol locations are fixed irrespective of physical cell-ID (e.g., the first PBCH-DMRS is located right after the SSS).

In other implementations, the locations of the PBCH-DMRS symbols may be based on the cell-ID, wherein the UE determines the PBCH-DMRS symbol location after PSS/SSS detection, as further described with reference to FIGS. 21-24. In the example of FIG. 21, the PBCH-DMRS are located in the fifth and eighth OFDM symbols, e.g., for

$${N}_{I D}^{c e l l} = 0 , where {N}_{I D}^{c e l l} ∈ \{ 0 , 1 , 2 , 3 \} , or {N}_{I D}^{c e l l} mod 4 = 0.$$

FIG. 22 illustrates an example of a time-spread SSB structure 2200 for a wireless network using DFT-S-OFDM in the DL direction, in accordance with aspects of the present disclosure. In the example of FIG. 22, the time-spread SSB structure 2200 has the same payload and components as the time-spread SSB structure 2100; however, the PBCH-DMRS are located in the sixth and ninth OFDM symbols, e.g., for

$${N}_{I D}^{c e l l} = 1 , where {N}_{I D}^{c e l l} ∈ \{ 0 , 1 , 2 , 3 \} , or {N}_{I D}^{c e l l} mod 4 = 1.$$

FIG. 23 illustrates an example of a time-spread SSB structure 2300 for a wireless network using DFT-S-OFDM in the DL direction, in accordance with aspects of the present disclosure. In the example of FIG. 23, the time-spread SSB structure 2300 has the same payload and components as the time-spread SSB structure 2100; however, the PBCH-DMRS are located in the seventh and tenth OFDM symbols, e.g., for

$${N}_{I D}^{c e l l} = 2 , where {N}_{I D}^{c e l l} ∈ \{ 0 , 1 , 2 , 3 \} , or {N}_{I D}^{c e l l} mod 4 = 2 .$$

FIG. 24 illustrates an example of a time-spread SSB structure 2400 for a wireless network using DFT-S-OFDM in the DL direction, in accordance with aspects of the present disclosure. In the example of FIG. 24, the time-spread SSB structure 2400 has the same payload and components as the time-spread SSB structure 2100; however, the PBCH-DMRS are located in the eighth and tenth OFDM symbols, e.g., for

$${N}_{I D}^{c e l l} = 3 , where {N}_{I D}^{c e l l} ∈ \{ 0 , 1 , 2 , 3 \} , or {N}_{I D}^{c e l l} mod 4 = 3.$$

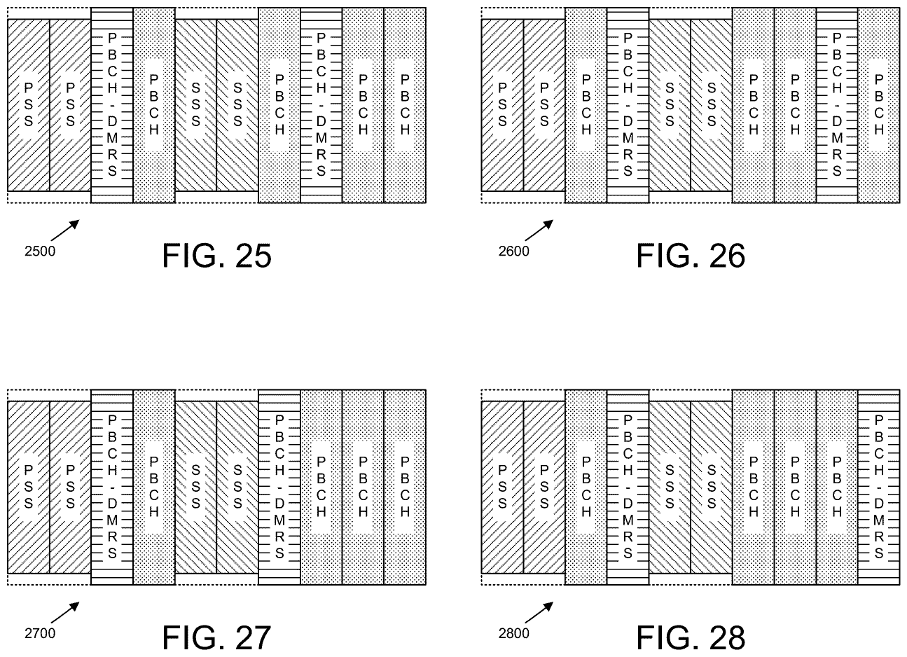

FIGS. 25-28 show examples of DMRS distribution within an SSB for situations where there are two PSS symbols, two SSS symbols, four PBCH payload symbols, and two PBCH-DMRS symbols. In the depicted examples, the PSS is located in the first and second symbols, the SSS is located in the fifth and sixth symbols, and the PBCH region comprises the third, fourth, seventh, eighth, ninth, and tenth symbols; however, other arrangements are within the scope of the present disclosure.

FIG. 25 illustrates an example of a time-spread SSB structure 2500 for a wireless network using DFT-S-OFDM in the DL direction, in accordance with aspects of the present disclosure. In the example of FIG. 25, the time-spread SSB structure 2500 has extended coverage as currently supported in 5G NR due to the presence of additional symbols. In some implementations of the time-spread SSB structure 2500, the PBCH-DMRS symbol locations are fixed irrespective of physical cell-ID (e.g., the first PBCH-DMRS is located right after the PSS).

In other implementations, the locations of the PBCH-DMRS symbols may be based on the cell-ID, wherein the UE determines the PBCH-DMRS symbol location after PSS/SSS detection, as further described with reference to FIGS. 25-28. In the example of FIG. 25, the PBCH-DMRS are located in the third and eighth OFDM symbols, e.g., for

$${N}_{I D}^{c e l l} = 2 , where {N}_{I D}^{c e l l} ∈ \{ 0 , 1 , 2 , 3 \} , or {N}_{I D}^{c e l l} mod 4 = 0.$$

FIG. 26 illustrates an example of a time-spread SSB structure 2600 for a wireless network using DFT-S-OFDM in the DL direction, in accordance with aspects of the present disclosure. In the example of FIG. 26, the time-spread SSB structure 2600 has the same payload and components as the time-spread SSB structure 2500; however, the PBCH-DMRS are located in the fourth and ninth OFDM symbols, e.g., for

$${N}_{I D}^{c e l l} = 1 , where {N}_{I D}^{c e l l} ∈ \{ 0 , 1 , 2 , 3 \} , or {N}_{I D}^{c e l l} mod 4 = 1 .$$

FIG. 27 illustrates an example of a time-spread SSB structure 2700 for a wireless network using DFT-S-OFDM in the DL direction, in accordance with aspects of the present disclosure. In the example of FIG. 27, the time-spread SSB structure 2700 has the same payload and components as the time-spread SSB structure 2500; however, the PBCH-DMRS are located in the third and seventh OFDM symbols, e.g., for

$${N}_{I D}^{c e l l} = 2 , where {N}_{I D}^{c e l l} ∈ \{ 0 , 1 , 2 , 3 \} , or {N}_{I D}^{c e l l} mod 4 = 2.$$

FIG. 28 illustrates an example of a time-spread SSB structure 2800 for a wireless network using DFT-S-OFDM in the DL direction, in accordance with aspects of the present disclosure. In the example of FIG. 28, the time-spread SSB structure 2800 has the same payload and components as the time-spread SSB structure 2500; however, the PBCH-DMRS are located in the fourth and tenth OFDM symbols, e.g., for

$${N}_{I D}^{c e l l} = 3 , where {N}_{I D}^{c e l l} ∈ \{ 0 , 1 , 2 , 3 \} , or {N}_{I D}^{c e l l} mod 4 = 3.$$

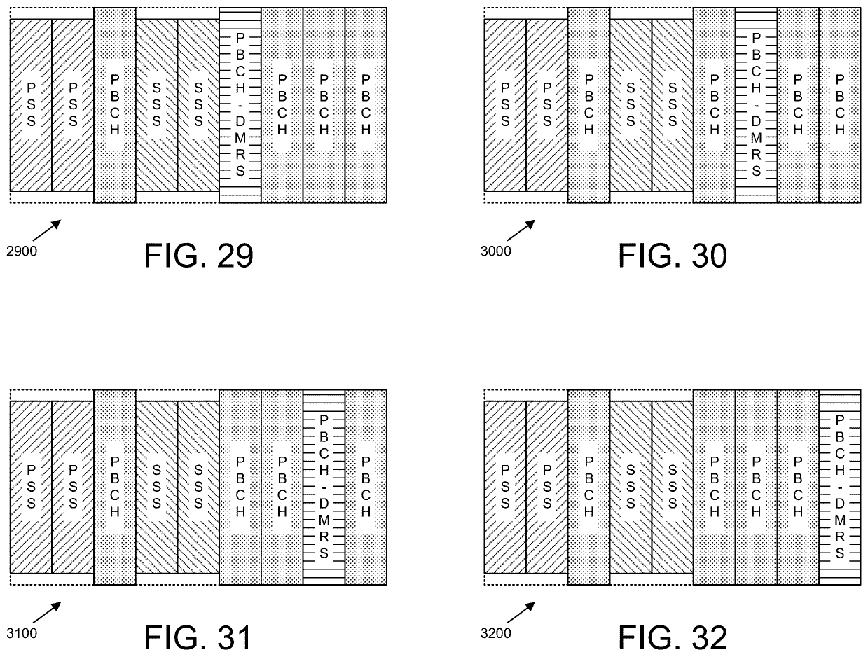

FIGS. 29-32 show examples of DMRS distribution within an SSB for situations where there are two PSS symbols, two SSS symbols, four PBCH payload symbols, and one PBCH-DMRS symbol. In the depicted examples, the PSS is located in the first and second symbols, the SSS is located in the fourth and fifth symbols, and the PBCH region comprises the third, sixth, seventh, eighth, ninth, and tenth symbols; however, other arrangements are within the scope of the present disclosure.

FIG. 29 illustrates an example of a time-spread SSB structure 2900 for a wireless network using DFT-S-OFDM in the DL direction, in accordance with aspects of the present disclosure. In the example of FIG. 29, the time-spread SSB structure 2900 has extended coverage as currently supported in 5G NR due to the presence of additional symbols. In some implementations of the time-spread SSB structure 2900, the location of the PBCH-DMRS symbol may be based on the cell-ID, wherein the UE determines the PBCH-DMRS symbol location after PSS/SSS detection, as further described with reference to FIGS. 29-32. Alternatively, the location of the PBCH-DMRS symbol may be based on a detected partial cell-ID, such as the PSS sequence ID,

$${N}_{I D}^{( 2 )} ,$$

wherein the UE determines the PBCH-DMRS symbol location after PSS detection. In the example of FIG. 29, the PBCH-DMRS is located in the sixth OFDM symbols, e.g., for

$${N}_{I D}^{c e l l} = 0 , where {N}_{I D}^{c e l l} ∈ \{ 0 , 1 , 2 , 3 \} , or {N}_{I D}^{c e l l} mod 4 = 0.$$

FIG. 30 illustrates an example of a time-spread SSB structure 3000 for a wireless network using DFT-S-OFDM in the DL direction, in accordance with aspects of the present disclosure. In the example of FIG. 30, the time-spread SSB structure 3000 has the same payload and components as the time-spread SSB structure 2900; however, the PBCH-DMRS is located in the seventh OFDM symbol, e.g., for

$${N}_{I D}^{c e l l} = 1 , where {N}_{I D}^{c e l l} ∈ \{ 0 , 1 , 2 , 3 \} , or {N}_{I D}^{c e l l} mod 4 = 1.$$

FIG. 31 illustrates an example of a time-spread SSB structure 3100 for a wireless network using DFT-S-OFDM in the DL direction, in accordance with aspects of the present disclosure. In the example of FIG. 31, the time-spread SSB structure 3100 has the same payload and components as the time-spread SSB structure 2900; however, the PBCH-DMRS is located in the eighth OFDM symbol, e.g., for

$${N}_{I D}^{c e l l} = 2 , where {N}_{I D}^{c e l l} ∈ \{ 0 , 1 , 2 , 3 \} , or {N}_{I D}^{c e l l} mod 4 = 2.$$

FIG. 32 illustrates an example of a time-spread SSB structure 3200 for a wireless network using DFT-S-OFDM in the DL direction, in accordance with aspects of the present disclosure. In the example of FIG. 32, the time-spread SSB structure 3200 has the same payload and components as the time-spread SSB structure 2900; however, the PBCH-DMRS is located in the ninth OFDM symbol, e.g., for

$${N}_{I D}^{c e l l} = 3 , where {N}_{I D}^{c e l l} ∈ \{ 0 , 1 , 2 , 3 \} , or {N}_{I D}^{c e l l} mod 4 = 3.$$

In some alternate implementations, the wireless network may only use the SSB arrangements shown in FIGS. 30 and 31. For example, the time-spread SSB structure 3000 may be used for

$${N}_{I D}^{c e l l} = 0 or 1 , where {N}_{I D}^{c e l l} ∈ \{ 0 , 1 , 2 , 3 \} , or {N}_{I D}^{c e l l} mod 4 = 0 or 1.$$

As another example, the time-spread SSB structure 3000 may be used for

$${N}_{I D}^{c e l l} = 2 or 3 , where {N}_{I D}^{c e l l} ∈ \{ 0 , 1 , 2 , 3 \} , or {N}_{I D}^{c e l l} mod 4 = 2 or 3.$$

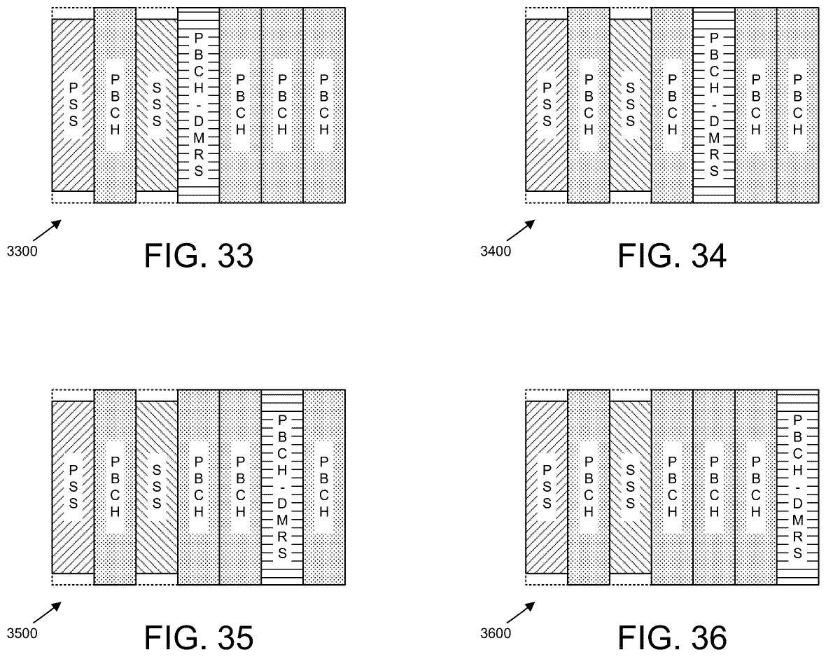

FIGS. 33-36 show examples of DMRS distribution within an SSB for situations where there is one PSS symbol, one SSS symbol, four PBCH payload symbols, and one PBCH-DMRS symbol. In the depicted examples, the PSS is located in the first symbol, the SSS is located in the third symbol, and the PBCH region comprises the second, fourth, fifth, sixth, and seventh symbols; however, other arrangements are within the scope of the present disclosure.

FIG. 33 illustrates an example of a time-spread SSB structure 3300 for a wireless network using DFT-S-OFDM in the DL direction, in accordance with aspects of the present disclosure. In the example of FIG. 33, the time-spread SSB structure 3300 has extended coverage as currently supported in 5G NR due to the presence of additional symbols. In some implementations of the time-spread SSB structure 3300, the location of the PBCH-DMRS symbol may be based on the cell-ID, wherein the UE determines the PBCH-DMRS symbol location after PSS/SSS detection, as further described with reference to FIGS. 33-36. Alternatively, the location of the PBCH-DMRS symbol may be based on a detected partial cell-ID, such as the PSS sequence ID,

$${N}_{I D}^{( 2 )} ,$$

wherein the UE determines the PBCH-DMRS symbol location after PSS detection. In the example of FIG. 33, the PBCH-DMRS is located in the fourth OFDM symbol, e.g., for

$${N}_{I D}^{c e l l} = 0 , where {N}_{I D}^{c e l l} ∈ \{ 0 , 1 , 2 , 3 \} , or {N}_{I D}^{c e l l} mod 4 = 0.$$

FIG. 34 illustrates an example of a time-spread SSB structure 3400 for a wireless network using DFT-S-OFDM in the DL direction, in accordance with aspects of the present disclosure. In the example of FIG. 34, the time-spread SSB structure 3400 has the same payload and components as the time-spread SSB structure 3300; however, the PBCH-DMRS is located in the fifth OFDM symbol, e.g., for

$${N}_{I D}^{c e l l} = 1 , where {N}_{I D}^{c e l l} ∈ \{ 0 , 1 , 2 , 3 \} , or {N}_{I D}^{c e l l} mod 4 = 1.$$

FIG. 35 illustrates an example of a time-spread SSB structure 3500 for a wireless network using DFT-S-OFDM in the DL direction, in accordance with aspects of the present disclosure. In the example of FIG. 35, the time-spread SSB structure 3500 has the same payload and components as the time-spread SSB structure 3300; however, the PBCH-DMRS is located in the sixth OFDM symbol, e.g., for

$${N}_{I D}^{c e l l} = 2 , where {N}_{I D}^{c e l l} ∈ \{ 0 , 1 , 2 , 3 \} , or {N}_{I D}^{c e l l} mod 4 = 2.$$

FIG. 36 illustrates an example of a time-spread SSB structure 3600 for a wireless network using DFT-S-OFDM in the DL direction, in accordance with aspects of the present disclosure. In the example of FIG. 36, the time-spread SSB structure 3600 has the same payload and components as the time-spread SSB structure 3300; however, the PBCH-DMRS is located in the seventh OFDM symbol, e.g., for

$${N}_{I D}^{c e l l} = 3 , where {N}_{I D}^{c e l l} ∈ \{ 0 , 1 , 2 , 3 \} , or {N}_{I D}^{c e l l} mod 4 = 3.$$

In various embodiments, considering the different available SSB structures (e.g., ranging from 4 symbols to 11 symbols), the transmission of the time-spread SSB may begin from the third symbol in a slot.

According to aspects of a third solution, the MIB and/or PBCH payload may be split into two parts (denoted “PBCH1” and “PBCH2”), considering that the same SSB is applicable to both device types (i.e., LPWA UEs and non-LPWA UEs) with different coverage requirements (and perhaps different PBCH acquisition time requirements), and noting that the PBCH content for each device type might be different. In some implementations, certain configurations and/or parameters may differ between the LPWA UEs and non-LPWA UEs. For example, the SCS (1 bit), the SSB Subcarrier Offset (5 bits), and/or the dmrs-TypeA-Position (1 bit) may not be applicable to the LPWA UEs, or may be pre-determined for the LPWA UEs. As another example, the PDCCH configuration for SIB1 (8 bits) might be different for LPWA UEs and eMBB UEs.

In some implementations, the PBCH2 may be coded with a lower coding rate compared to that of PBCH1, such that the non-LPWA UEs decode at least the PBCH1 (and perhaps also the PBCH2) while the LPWA UEs decode PBCH2 only. Beneficially, not all the PBCH payload (PBCH1 and PBCH2) would be transmitted with a lower coding rate to satisfy the extended coverage UE.

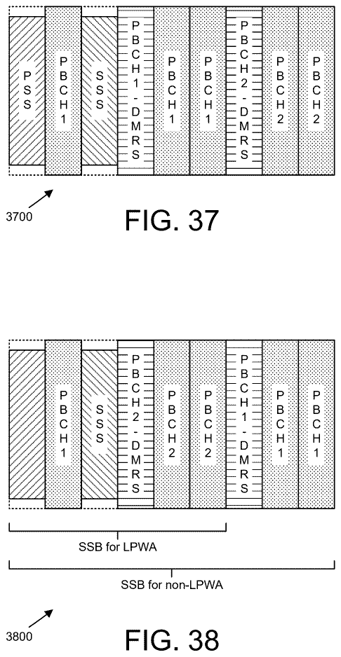

FIG. 37 illustrates an example of a time-spread SSB structure 3700 for a wireless network using DFT-S-OFDM in the DL direction, in accordance with aspects of the present disclosure. In the example of FIG. 37, there is one PSS symbol, one SSS symbol, five PBCH payload symbols, and two PBCH-DMRS symbol. In the depicted examples, the PSS is located in the first symbol, the SSS is located in the third symbol, and the PBCH region comprises the second, fourth, fifth, sixth, seventh, eighth, and ninth OFDM symbols; however, other arrangements are within the scope of the present disclosure. The time-spread SSB structure 3700 has extended coverage as currently supported in 5G NR due to the presence of additional symbols.

Moreover, in the time-spread SSB structure 3700, the PBCH is split into a first subset of symbols (e.g., PBCH1) associated with a first payload and a second subset of symbols (e.g., PBCH2) associated with a second payload. Here, the PBCH1 contains ‘X1’ bit payload with coding rate ‘R1’; and the PBCH2 contains ‘X2’ bit payload with coding rate ‘R2’, where ‘X1’>‘X2’, and ‘R1’>‘R2’. In some examples, the PBCH1 comprises the second, fifth, and sixth OFDM symbols, while the PBCH2 comprises the eighth and ninth OFDM symbols. However, in other implementations, the number of symbols for PBCH2 may be greater than the number of symbols for PBCH1.

One justification for the bit payload of PBCH1 exceeding the bit payload of PBCH2 (i.e., ‘X1’>‘X2’) is that some parameters indicated in PBCH/MIB may not be applicable to LPWA UEs (e.g., the SCS indication, since SCS for LPWA UEs may be a preset value, such as 15 KHz) or the corresponding value maybe preconfigured/pre-determined for LPWA UEs (e.g., SSB-to-CORESET0 offset can be set to 0).

As depicted in FIG. 37, the PBCH-DMRS symbols may include a first PBCH-DMRS (denoted “PBCH1-DMRS”) associated with the PBCH1, and a second PBCH-DMRS (denoted “PBCH2-DMRS”) associated with the PBCH2. In some examples, the PBCH1-DMRS is located in the fourth OFDM symbol, while the PBCH2-DMRS is located in the seventh OFDM symbol. However, in other implementations, the PBCH1 and PBCH2 may have same DMRS symbol(s).

One benefit of the time-spread SSB structure 3700 is that a non-LPWA UE can improve power savings by only decoding a first portion of the time-spread SSB. In the example of FIG. 37, the non-LPWA UE only needs to decode the first 6 OFDM symbols.

FIG. 38 illustrates an example of a time-spread SSB structure 3800 for a wireless network using DFT-S-OFDM in the DL direction, in accordance with aspects of the present disclosure. The time-spread SSB structure 3800 depicts a split PBCH arrangement, having different coding rates for the PBCH1 and PBCH2, as described above.

Moreover, the time-spread SSB structure 3800 depicts an alternative arrangement of SSB components, such that PBCH2 comes earlier than PBCH1. One benefit of the time-spread SSB structure 3800 is that a LPWA UE can improve power savings by only decoding a first portion of the time-spread SSB. In the example of FIG. 38, the LPWA UE only needs to decode the first 6 OFDM symbols. However, the non-LPWA UE would need to decode all 9 OFDM symbols due to the PBCH1 being located after the PBCH2.

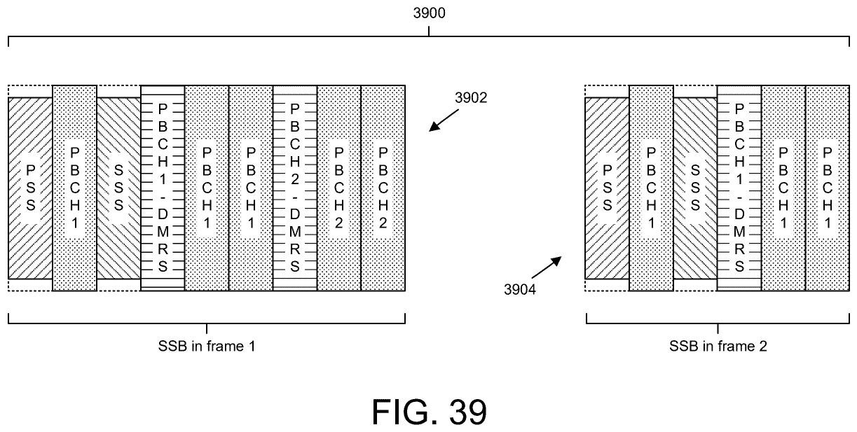

FIG. 39 illustrates an example of a time-spread SSB structure 3900 with dynamic SSB length, in accordance with aspects of the present disclosure. In the example of FIG. 39, a first SSB transmission instance 3902 is transmitted in a first frame, and a second SSB transmission instance 3904 is transmitted in a second frame, where the first SSB transmission instance 3902 and second SSB transmission instance 3904 have different lengths, e.g., as a function of time. An SSB transmission occurs once every frame. In some examples, the SSB length is 9 symbols in the odd frames, and the SSB length is 6 symbols in even frames.

As depicted, the first SSB transmission instance 3902 transmitted in frame 1 has a composition and arrangement similar to the time-spread SSB structure 3700, i.e., there is one PSS symbol, one SSS symbol, five PBCH payload symbols, and two PBCH-DMRS symbol, and the PBCH is split into a PBCH1 occupying the second, fifth, and sixth symbols (with a corresponding PBCH1-DMRS in the fourth symbol), and a PBCH2 occupying the eighth and ninth symbols (with a corresponding PBCH2-DMRS in the seventh symbol).

Moreover, the second SSB transmission instance 3904 transmitted in frame 2 has a composition and arrangement similar to the time-spread SSB structure 500, where there is one PSS symbol, one SSS symbol, three PBCH payload symbols, and one PBCH-DMRS symbol located in the fourth OFDM symbol. In the example of FIG. 39, the PBCH payload in the second SSB transmission instance 3904 is the same PBCH1 payload transmitted in the first SSB transmission instance 3902, and the PBCH-DMRS in the second SSB transmission instance 3904 is the same PBCH1-DMRS transmitted in the first SSB transmission instance 3902.

However, in other implementations, the first SSB transmission instance 3902 transmitted in frame 1 may have a composition and arrangement similar to the time-spread SSB structure 3800, and the second SSB transmission instance 3904 may carry the PBCH2 payload and the PBCH2-DMRS.

One benefit of the time-spread SSB structure 3900 with dynamic SSB length is that the dynamic SSB length (e.g., as a function of time) allows the network (e.g., NE 102 or gNB) to shorten the SSB length in cells with no LPWA UEs or only small amount of LPWA UEs (e.g., fewer than a threshold), thereby reducing SSB overhead by allowing DL transmissions in the symbols not used for SSB transmission, e.g., the symbols after the last PBCH1 in frame 2 as shown in FIG. 39.

In some implementations, to provide the network with flexibility of using the first or the second SSB structures shown in FIG. 37 and FIG. 38, at least one of the PBCH1-DMRS and PBCH2-DMRS sequences can indicate the SSB structure (e.g., amongst the SSB structures shown in FIG. 37 and FIG. 38).

In some implementations, the network may indicate whether non-LPWA UEs need to decode both PBCH1 and PBCH2 or only PBCH1. Alternatively, this information may be pre-programmed or pre-configured in the non-LPWA UEs.

In some implementations, the network may indicate whether the PBCH1 content is according to a first format or a second format. For instance, the PBCH1-DMRS may indicate whether the half-frame bit is included in the PBCH1 or the PBCH2. Alternatively, this information may be pre-programmed or pre-configured in the LPWA UEs and/or non-LPWA UEs.

For situations where the non-LPWA UEs decode both the PBCH1 and the PBCH2, and where both PBCHs contain the same information field (e.g., half-frame, SFN), the non-LPWA UEs do not expect the two information field values to be different.

Irrespective of whether the PBCH is split into two separate PBCHs or not, the PBCH-DMRS sequence may indicate the number of PBCH symbols and associated DMRS within an SSB. For instance, even with a single PBCH (i.e., non-split PBCH), in one SSB transmission instance, the SSB may contain more PBCH and DMRS symbols than other instances, e.g., to balance the SSB overhead according to the number of LPWA UEs and non-LPWA UEs in a cell, or according to a ratio of LPWA UEs to non-LPWA UEs in the cell.

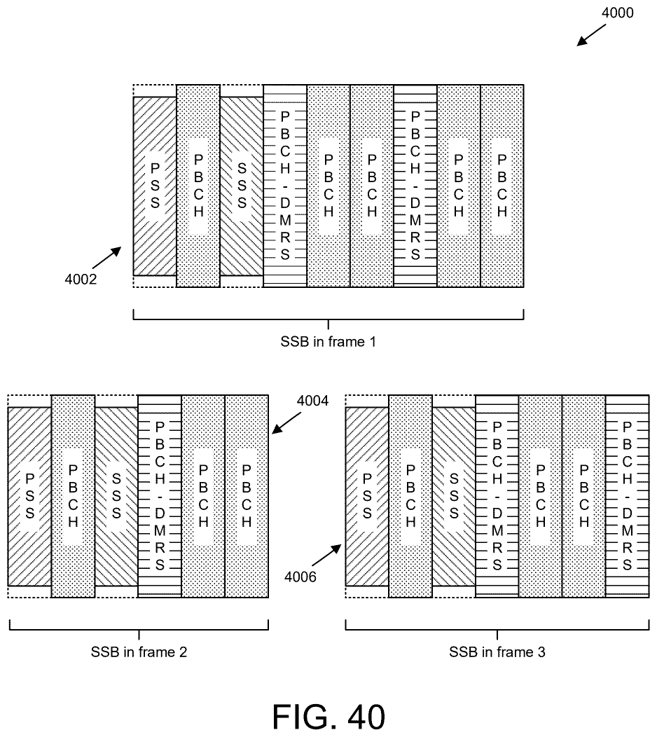

FIG. 40 illustrates an example of a time-spread SSB structure 4000 with dynamic SSB length, in accordance with aspects of the present disclosure. In the example of FIG. 40, a first SSB transmission instance 4002 is transmitted in a first frame, a second SSB transmission instance 4004 is transmitted in a second frame, and a third SSB transmission instance 4006 is transmitted in a third frame. In the depicted implementation, the first SSB transmission instance 4002, the second SSB transmission instance 4004, and the third SSB transmission instance 4006 have different lengths and contain {9, 6, 7} symbols, respectively. An SSB transmission occurs once every frame.

In the depicted examples, the first SSB transmission instance 4002 transmitted in frame 1 has one PSS symbol, one SSS symbol, five PBCH payload symbols, and two PBCH-DMRS symbol, where the PSS is located in the first symbol, the SSS is located in the third symbol, and the PBCH region comprises the second, fourth, fifth, sixth, seventh, eighth, and ninth symbols, with the PBCH-DMRS located in the fifth and seventh symbols; however, other arrangements are within the scope of the present disclosure.

Moreover, the second SSB transmission instance 4004 transmitted in frame 2 has a composition and arrangement similar to the time-spread SSB structure 500, where there is one PSS symbol, one SSS symbol, three PBCH payload symbols, and one PBCH-DMRS symbol located in the fourth OFDM symbol.

Additionally, the third SSB transmission instance 4006 transmitted in frame 3 has a composition and arrangement similar to the time-spread SSB structure 1200, where there is one PSS symbol, one SSS symbol, three PBCH payload symbols, and two PBCH-DMRS symbol located in the fourth and seventh OFDM symbols.

In the example of FIG. 40, the PBCH payload in the second SSB transmission instance 4004 is the same PBCH1 payload transmitted in the first SSB transmission instance 4002, and the PBCH-DMRS in the second SSB transmission instance 4004 is the same PBCH1-DMRS transmitted in the first SSB transmission instance 4002.

In some implementations, the PBCH-DMRS sequence may indicate the PBCH payload size and/or the coding rate of the PBCH payload.

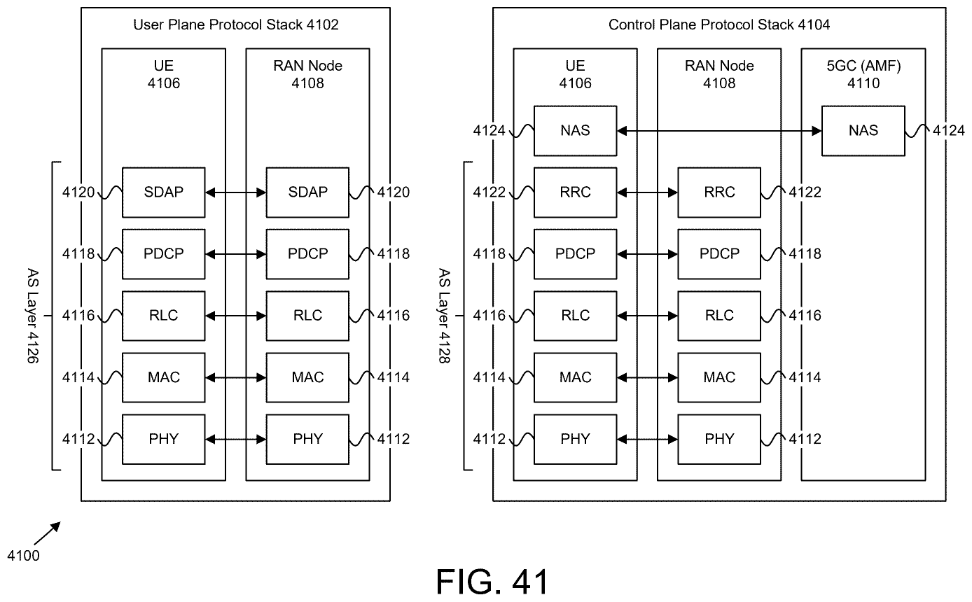

FIG. 41 illustrates an example of a protocol stack 4100, in accordance with aspects of the present disclosure. While FIG. 41 shows a UE 4106, a RAN node 4108, and a 5GC 4110 (e.g., comprising at least an AMF), these are representative of a set of UEs 104 interacting with an NE 102 (e.g., base station) and a CN 106. As depicted, the protocol stack 4100 comprises a user plane protocol stack 4102 and a control plane protocol stack 4104. The user plane protocol stack 4102 includes a physical (PHY) layer 4112, a MAC sublayer 4114, a radio link control (RLC) sublayer 4116, a packet data convergence protocol (PDCP) sublayer 4118, and a service data adaptation protocol (SDAP) layer 4120. The control plane protocol stack 4104 includes a PHY layer 4112, a MAC sublayer 4114, a RLC sublayer 4116, and a PDCP sublayer 4118. The control plane protocol stack 4104 also includes a radio resource control (RRC) layer 4122 and a non-access stratum (NAS) layer 4124.

The AS layer 4126 (also referred to as “AS protocol stack”) for the User Plane protocol stack 4102 consists of at least SDAP, PDCP, RLC and MAC sublayers, and the physical layer. The AS layer 4128 for the Control Plane protocol stack 4104 consists of at least the RRC layer 4122, the PDCP sublayer 4118, the RLC sublayer 4116, the MAC sublayer 4114, and the PHY layer 4112. The layer-1 (L1) includes the PHY layer 4112. The layer-2 (L2) is split into the SDAP sublayer 4120, PDCP sublayer 4118, RLC sublayer 4116, and MAC sublayer 4114. The layer-3 (L3) includes the RRC layer 4122 and the NAS layer 4124 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 4112 offers transport channels to the MAC sublayer 4114. The PHY layer 4112 may perform a beam failure detection procedure using energy detection thresholds, as described herein. In certain implementations, the PHY layer 4112 may send an indication of beam failure to a MAC entity at the MAC sublayer 4114. The MAC sublayer 4114 offers logical channels (LCHs) to the RLC sublayer 4116. The RLC sublayer 4116 offers RLC channels to the PDCP sublayer 4118.

The PDCP sublayer 4118 offers radio bearers to the SDAP sublayer 4120 and/or RRC layer 4122. The SDAP sublayer 4120 offers QoS flows to the core network (e.g., 5GC). The RRC layer 4122 provides for the addition, modification, and release of carrier aggregation (CA) and/or dual connectivity. The RRC layer 4122 also manages the establishment, configuration, maintenance, and release of signaling radio bearers (SRBs) and data radio bearers (DRBs).

The NAS layer 4124 is between the UE 4106 and an AMF in the 5GC 4110. NAS messages are passed transparently through the RAN. The NAS layer 4124 is used to manage the establishment of communication sessions and for maintaining continuous communications with the UE 4106 as it moves between different cells of the RAN. In contrast, the AS layers 4126 and 4128 are between the UE 4106 and the RAN (i.e., RAN node 4108) and carry information over the wireless portion of the network. While not depicted in FIG. 41, the IP layer exists above the NAS layer 4124, a transport layer exists above the IP layer, and an application layer exists above the transport layer.

The MAC sublayer 4114 is the lowest sublayer in the L2 architecture of the NR protocol stack. Its connection to the PHY layer 4112 below is through transport channels, and the connection to the RLC sublayer 4116 above is through LCHs. The MAC sublayer 4114 therefore performs multiplexing and demultiplexing between LCHs and transport channels: the MAC sublayer 4114 in the transmitting side constructs MAC PDUs (also known as transport blocks (TBs)) from MAC service data units (SDUs) received through LCHs, and the MAC sublayer 4114 in the receiving side recovers MAC SDUs from MAC PDUs received through transport channels.

The MAC sublayer 4114 provides a data transfer service for the RLC sublayer 4116 through LCHs, which are either control LCHs which carry control data (e.g., RRC signaling) or traffic LCHs which carry user plane data. On the other hand, the data from the MAC sublayer 4114 is exchanged with the PHY layer 4112 through transport channels, which are classified as UL or DL. Data is multiplexed into transport channels depending on how it is transmitted over the air.

The PHY layer 4112 is responsible for the actual transmission of data and control information via the air interface, i.e., the PHY layer 4112 carries all information from the MAC transport channels over the air interface on the transmission side. Some of the important functions performed by the PHY layer 4112 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 4122. The PHY layer 4112 performs transmissions based on transmission parameters, such as the modulation scheme, the coding rate (i.e., the modulation and coding scheme (MCS)), the number of physical resource blocks (PRBs), etc.

In some implementations, the protocol stack 4100 may be an NR protocol stack used in a 5G NR system. In other implementations, the protocol stack 4100 may be an LTE protocol stack used in a 4G LTE system Note that an LTE protocol stack comprises similar structure to the protocol stack 4100, with the differences that the LTE protocol stack lacks the SDAP sublayer 4120 in the AS layer 4126, that an EPC replaces the 5GC 4110, and that the NAS layer 4124 is between the UE 4106 and an MME in the EPC.

Also note that the present disclosure distinguishes between a protocol layer (e.g., as shown in FIG. 41) and a transmission layer in multiple-input multiple-output (MIMO) communication. Examples of a protocol layer includes the aforementioned PHY layer 4112, MAC sublayer 4114, RLC sublayer 4116, PDCP sublayer 4118, SDAP sublayer 4120, RRC layer 4122 and NAS layer 4124. In certain embodiments, a transmission layer may also be referred to as a “MIMO layer” or a “data stream.”

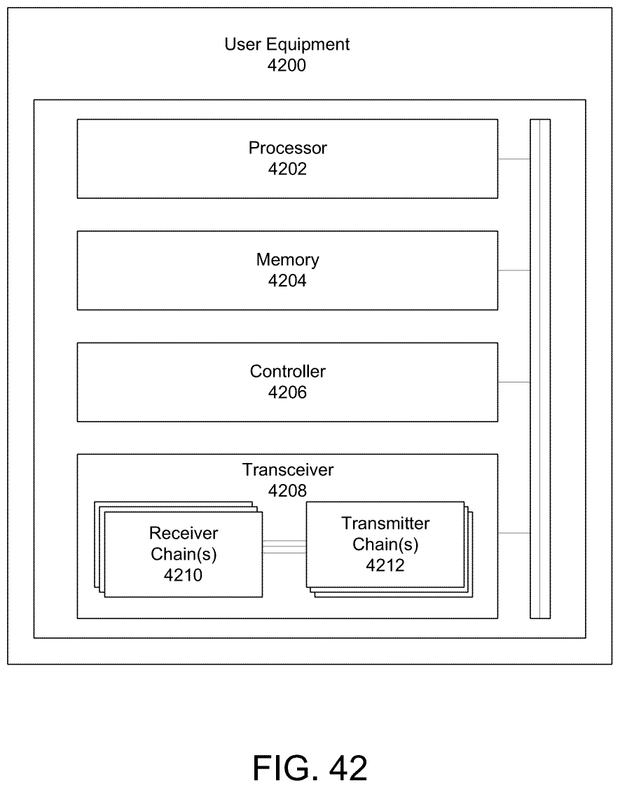

FIG. 42 illustrates an example of a UE 4200 in accordance with aspects of the present disclosure. The UE 4200 may include a processor 4202, a memory 4204, a controller 4206, and a transceiver 4208. The processor 4202, the memory 4204, the controller 4206, or the transceiver 4208, or various combinations thereof or various components thereof may be examples of means for performing various aspects of the present disclosure as described herein. These components may be coupled (e.g., operatively, communicatively, functionally, electronically, electrically) via one or more interfaces.

The processor 4202, the memory 4204, the controller 4206, or the transceiver 4208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 4202 may include an intelligent hardware device (e.g., a general-purpose processor, a DSP, a central processing unit (CPU), an ASIC, a field programmable gate array (FPGA), or any combination thereof). In some implementations, the processor 4202 may be configured to operate the memory 4204. In some other implementations, the memory 4204 may be integrated into the processor 4202. The processor 4202 may be configured to execute computer-readable instructions stored in the memory 4204 to cause the UE 4200 to perform various functions of the present disclosure.

The memory 4204 may include volatile or non-volatile memory. The memory 4204 may store computer-readable, computer-executable code including instructions that, when executed by the processor 4202, cause the UE 4200 to perform various functions described herein. The code may be stored in a non-transitory computer-readable medium such the memory 4204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 4202 and the memory 4204 coupled with the processor 4202 may be configured to cause the UE 4200 to perform various functions (e.g., operations, signaling) described herein (e.g., executing, by the processor 4202, instructions stored in the memory 4204). In some implementations, the processor 4202 may include multiple processors and the memory 4204 may include multiple memories. One or more of the multiple processors may be coupled with one or more of the multiple memories, which may be individually or collectively, configured to perform various functions (e.g., operations, signaling) of the UE 4200 as described herein.

The processor 4202 coupled with the memory 4204 may be configured to, capable of, or operable to cause the UE 4200 to receive a SSB associated with a cell, wherein the SSB spans a plurality of symbols (e.g., OFDM symbols, or similar time-domain units) and comprises at least a first set of symbols and a second set of symbols mutually exclusive to the first set of symbols; determine one or more symbol locations of the second set of symbols (i.e., a time-domain location of the second set of symbols) is based at least in part on an identifier of the cell (e.g., cell-ID); decode a reference signal (e.g., the DMRS) within the second set of symbols; and decode a broadcast channel (e.g., PBCH) within the first set of symbols based at least in part on the decoded reference signal. In some examples, the first set of symbols corresponds to a PBCH, and the second set of symbols corresponds to a DMRS.

In some implementations, the processor 4202 coupled with the memory 4204 may be configured to, capable of, or operable to cause the UE 4200 to A) detect a set of synchronization signals based at least in part on the received SSB, where the SSB comprises the set of synchronization signals, the broadcast channel (e.g., PBCH), and the reference signal (e.g., DMRS); and B) determine at least a portion of the identifier of the cell based at least in part on the detected set of synchronization signals.

In some implementations, the first set of symbols (e.g., corresponding to the PBCH) comprises a first subset of symbols associated with a first payload and a second subset of symbols associated with a second payload, where the first subset of symbols and the second subset of symbols are non-overlapping. In certain implementations, the first subset of symbols corresponds to a first PBCH portion (e.g., PBCH1) and the second subset of symbols corresponds to a second PBCH portion (e.g., PBCH2) within the SSB. In some examples, the first and second subsets of symbols correspond to OFDM symbols, or similar time-domain units. In such implementations, the processor 4202 coupled with the memory 4204 may be configured to, capable of, or operable to cause the UE 4200 to receive an indication to decode the first subset of symbols, or the second subset of symbols, or both, based at least in part on a type of the UE (e.g., LPWA type or non-LPWA type). In certain implementations, the first subset of symbols and the second subset of symbols are non-overlapping symbols (e.g., the PBCH is split).

In certain implementations, the reference signal (e.g., DMRS) is indicative of an order (e.g., arrangement) of the first subset of symbols (e.g., PBCH1) and the second subset of symbols (e.g., PBCH2) within the SSB. In other words, the arrangement indicated in the reference signal (e.g., DMRS) may specify 1) which symbols belong to each subset, 2) a number of symbols in each subset, or both. In some examples, the reference signal (e.g., DMRS) is indicative of the time-domain locations of the first subset of symbols (e.g., PBCH1) and the second subset of symbols (e.g., PBCH2). In other words, the reference signal (e.g., DMRS) may indicate one or more symbol locations corresponding to the first subset of symbols (e.g., PBCH1) and one or more symbol locations corresponding to the second subset of symbols (e.g., PBCH2).

In certain implementations, the reference signal (e.g., DMRS) is associated with the first subset of symbols, or the second subset of symbols, or both. In some examples, the SSB comprises a split DMRS, where a first set of reference signals (e.g., PBCH1-DMRS) is associated with the first subset of symbols (e.g., PBCH1) and a second set of reference signals (e.g., PBCH2-DMRS) is associated with the second subset of symbols (e.g., PBCH2). In certain implementations, the first subset of symbols (e.g., PBCH1) occurs earlier in the time domain than the second subset of symbols (e.g., PBCH2).

In certain implementations, the broadcast channel (e.g., PBCH) comprises a subset of information provided in both the first subset of symbols (e.g., PBCH1) and the second subset of symbols (e.g., PBCH2). In other words, a portion of the information in PBCH1 is also in PBCH2 (i.e., same information).

In some examples, the reference signal (e.g., DMRS) indicates the payload size(s) or the coding rate(s), or both, associated with the broadcast channel (e.g., PBCH) or subchannels (e.g., PBCH1, PBCH2). In certain implementations, the size of the first payload (e.g., PBCH1 size) is greater (e.g., larger) than the size of the second payload (e.g., PBCH2 size). In certain implementations, a coding rate associated with the first payload (e.g., PBCH1 coding rate) is higher than a coding rate associated with the second payload (e.g., PBCH2 is encoded with a lower coding rate than PBCH1).

In some implementations, the cardinality (i.e., the number of elements in the set) of the first set of symbols is four, and the cardinality of the second set of symbols is one.

In some implementations, to decode the broadcast channel (e.g., PBCH), the processor 4202 coupled with the memory 4204 may be configured to, capable of, or operable to cause the UE 4200 to: A) determine a time reference based at least in part on the SSB; B) select one or more symbols for decoding the broadcast channel based at least in part on the time reference; and C) decode the broadcast channel (e.g., PBCH) based at least in part on the selected one or more symbols.

In certain implementations, the time reference comprises a system frame number (SFN), and the SSB is part of a set of SSBs. In such embodiments, the processor 4202 coupled with the memory 4204 may be configured to, capable of, or operable to cause the UE 4200 to: A) determine a respective SFN for each SSB of the set of SSBs; and B) select the one or more symbols for decoding the broadcast channel (e.g., PBCH) is selected based at least in part on the SFN. In other implementations, the time reference comprises a half-frame (e.g., a subdivision of a single radio frame, equal to half of the radio frame). As described above with reference to FIGS. 39 and 40, the SSB structure may be time-varying with dynamic length, such that which symbols correspond to the PBCH may be based on the SFN and/or half-frame.

In some implementations, the SSB is composed of the set of synchronization signals, the PBCH, and the DMRS. In certain implementations, the set of synchronization signals comprises a set of PSS and a set of SSS. In certain implementations, the set of PSS is offset from the set of SSS by at least one symbol belonging to the first set of symbols or the second set of symbols. In certain implementations, the processor 4202 coupled with the memory 4204 may be configured to, capable of, or operable to cause the UE 4200 to determine the SFN based at least in part on the PSS, the SSS, or the reference signal, or a combination thereof.

The controller 4206 may manage input and output signals for the UE 4200. The controller 4206 may also manage peripherals not integrated into the UE 4200. In some implementations, the controller 4206 may utilize an operating system (OS) such as iOS®, ANDROID®, WINDOWS®, or other operating systems. In some implementations, the controller 4206 may be implemented as part of the processor 4202.

In some implementations, the UE 4200 may include at least one transceiver 4208. In some other implementations, the UE 4200 may have more than one transceiver 4208. The transceiver 4208 may represent a wireless transceiver. The transceiver 4208 may include one or more receiver chains 4210, one or more transmitter chains 4212, or a combination thereof.

A receiver chain 4210 may be configured to receive signals (e.g., control information, data, packets) over a wireless medium. For example, the receiver chain 4210 may include one or more antennas for receiving the signal over the air or wireless medium. The receiver chain 4210 may include at least one amplifier (e.g., a low-noise amplifier (LNA)) configured to amplify the received signal. The receiver chain 4210 may include at least one demodulator configured to demodulate the received signal and obtain the transmitted data by reversing the modulation technique applied during transmission of the signal. The receiver chain 4210 may include at least one decoder for decoding/processing the demodulated signal to receive the transmitted data.

A transmitter chain 4212 may be configured to generate and transmit signals (e.g., control information, data, packets). The transmitter chain 4212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 4212 may also include at least one power amplifier configured to amplify the modulated signal to an appropriate power level suitable for transmission over the wireless medium. The transmitter chain 4212 may also include one or more antennas for transmitting the amplified signal into the air or wireless medium.

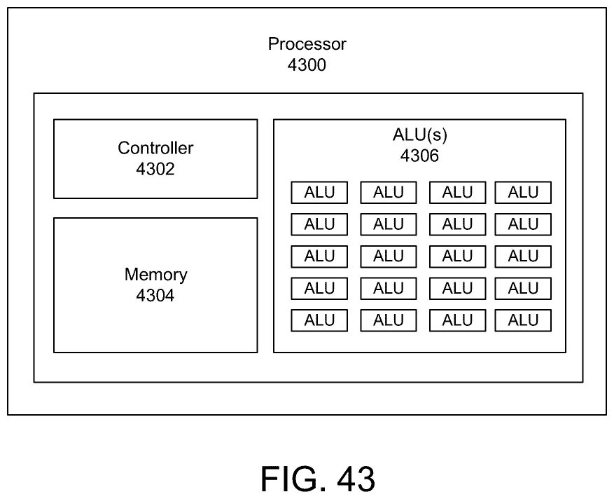

FIG. 43 illustrates an example of a processor 4300 in accordance with aspects of the present disclosure. The processor 4300 may be an example of a processor configured to perform various operations in accordance with examples as described herein. The processor 4300 may include a controller 4302 configured to perform various operations in accordance with examples as described herein. The processor 4300 may optionally include at least one memory 4304, which may be, for example, an L1, or L2, or L3 cache. Additionally, or alternatively, the processor 4300 may optionally include one or more arithmetic-logic units (ALUs) 4306. One or more of these components may be in electronic communication or otherwise coupled (e.g., operatively, communicatively, functionally, electronically, electrically) via one or more interfaces (e.g., buses).

The processor 4300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 4300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 4302 may be configured to manage and coordinate various operations (e.g., signaling, receiving, obtaining, retrieving, transmitting, outputting, forwarding, storing, determining, identifying, accessing, writing, reading) of the processor 4300 to cause the processor 4300 to support various operations in accordance with examples as described herein. For example, the controller 4302 may operate as a control unit of the processor 4300, generating control signals that manage the operation of various components of the processor 4300. These control signals include enabling or disabling functional units, selecting data paths, initiating memory access, and coordinating timing of operations.

The controller 4302 may be configured to fetch (e.g., obtain, retrieve, receive) instructions from the memory 4304 and determine subsequent instruction(s) to be executed to cause the processor 4300 to support various operations in accordance with examples as described herein. The controller 4302 may be configured to track memory address of instructions associated with the memory 4304. The controller 4302 may be configured to decode instructions to determine the operation to be performed and the operands involved. For example, the controller 4302 may be configured to interpret the instruction and determine control signals to be output to other components of the processor 4300 to cause the processor 4300 to support various operations in accordance with examples as described herein. Additionally, or alternatively, the controller 4302 may be configured to manage flow of data within the processor 4300. The controller 4302 may be configured to control transfer of data between registers, arithmetic logic units (ALUs), and other functional units of the processor 4300.

The memory 4304 may include one or more caches (e.g., memory local to or included in the processor 4300 or other memory, such RAM, ROM, DRAM, SDRAM, SRAM, MRAM, flash memory, etc. In some implementations, the memory 4304 may reside within or on a processor chipset (e.g., local to the processor 4300). In some other implementations, the memory 4304 may reside external to the processor chipset (e.g., remote to the processor 4300).

The memory 4304 may store computer-readable, computer-executable code including instructions that, when executed by the processor 4300, cause the processor 4300 to perform various functions described herein. The code may be stored in a non-transitory computer-readable medium such as system memory or another type of memory. The controller 4302 and/or the processor 4300 may be configured to execute computer-readable instructions stored in the memory 4304 to cause the processor 4300 to perform various functions. For example, the processor 4300 and/or the controller 4302 may be coupled with or to the memory 4304, the processor 4300, the controller 4302, and the memory 4304 may be configured to perform various functions described herein. In some examples, the processor 4300 may include multiple processors and the memory 4304 may include multiple memories. One or more of the multiple processors may be coupled with one or more of the multiple memories, which may, individually or collectively, be configured to perform various functions herein.

The one or more ALUs 4306 may be configured to support various operations in accordance with examples as described herein. In some implementations, the one or more ALUs 4306 may reside within or on a processor chipset (e.g., the processor 4300). In some other implementations, the one or more ALUs 4306 may reside external to the processor chipset (e.g., the processor 4300). One or more ALUs 4306 may perform one or more computations such as addition, subtraction, multiplication, and division on data. For example, one or more ALUs 4306 may receive input operands and an operation code, which determines an operation to be executed. One or more ALUs 4306 be configured with a variety of logical and arithmetic circuits, including adders, subtractors, shifters, and logic gates, to process and manipulate the data according to the operation. Additionally, or alternatively, the one or more ALUs 4306 may support logical operations such as AND, OR, exclusive-OR (XOR), not-OR (NOR), and not-AND (NAND), enabling the one or more ALUs 4306 to handle conditional operations, comparisons, and bitwise operations.

In some implementations, the processor 4300 may support various functions (e.g., operations, signaling) of a UE, in accordance with examples as disclosed herein. For example, the controller 4302 coupled with the memory 4304 may be configured to, capable of, or operable to cause the processor 4300 to receive a SSB associated with a cell, where the SSB spans a plurality of symbols and comprises at least a first set of symbols and a second set of symbols mutually exclusive to the first set of symbols; determine one or more symbol locations of the second set of symbols is based at least in part on an identifier of the cell (e.g., cell-ID); decode a reference signal (e.g., DMRS) within the second set of symbols; and decode a broadcast channel (e.g., PBCH) within the first set of symbols based at least in part on the decoded reference signal (e.g., DMRS). Additionally, the controller 4302 coupled with the memory 4304 may be configured to, capable of, or operable to cause the processor 4300 to perform one or more functions (e.g., operations, signaling) of the UE as described herein.

Additionally, or alternatively, in some other implementations, the processor 4300 may support various functions (e.g., operations, signaling) of a NE (e.g., base station), in accordance with examples as disclosed herein. For example, the controller 4302 coupled with the memory 4304 may be configured to, capable of, or operable to cause the processor 4300 to transmit a SSB associated with a cell, where the SSB spans a plurality of symbols and comprises at least a first set of symbols and a second set of symbols mutually exclusive to the first set of symbols; transmit a broadcast channel (e.g., PBCH) within the first set of symbols; and transmit a reference signal (e.g., DMRS) corresponding to the broadcast channel (e.g., PBCH) within the second set of symbols, where one or more symbol locations of the second set of symbols is based at least in part on an identifier of the cell. Additionally, the controller 4302 coupled with the memory 4304 may be configured to, capable of, or operable to cause the processor 4300 to perform one or more functions (e.g., operations, signaling) of the NE as described herein.

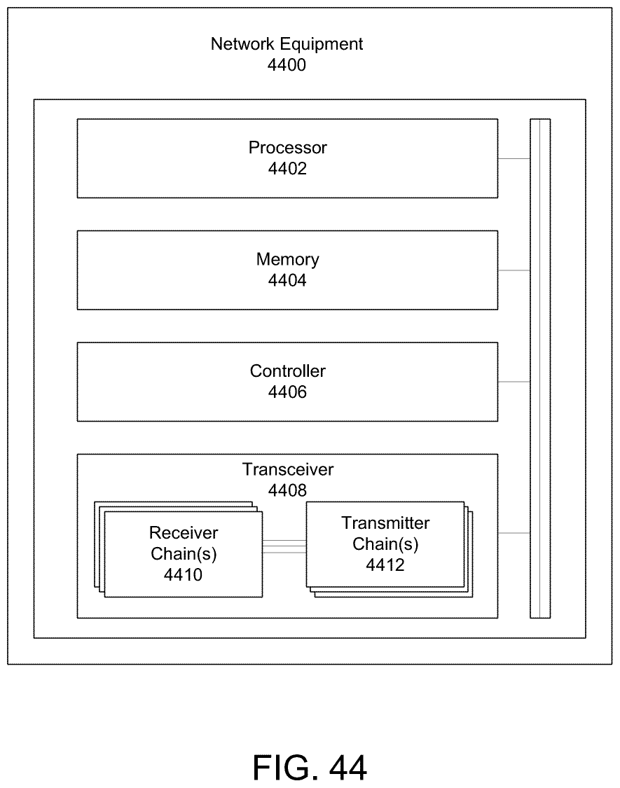

FIG. 44 illustrates an example of a NE 4400 in accordance with aspects of the present disclosure. The NE 4400 may include a processor 4402, a memory 4404, a controller 4406, and a transceiver 4408. The processor 4402, the memory 4404, the controller 4406, or the transceiver 4408, or various combinations thereof or various components thereof may be examples of means for performing various aspects of the present disclosure as described herein. These components may be coupled (e.g., operatively, communicatively, functionally, electronically, electrically) via one or more interfaces.

The processor 4402, the memory 4404, the controller 4406, or the transceiver 4408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 4402 may include an intelligent hardware device (e.g., a general-purpose processor, a DSP, a CPU, an ASIC, an FPGA, or any combination thereof). In some implementations, the processor 4402 may be configured to operate the memory 4404. In some other implementations, the memory 4404 may be integrated into the processor 4402. The processor 4402 may be configured to execute computer-readable instructions stored in the memory 4404 to cause the NE 4400 to perform various functions of the present disclosure.

The memory 4404 may include volatile or non-volatile memory. The memory 4404 may store computer-readable, computer-executable code including instructions when executed by the processor 4402 cause the NE 4400 to perform various functions described herein. The code may be stored in a non-transitory computer-readable medium such the memory 4404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 4402 and the memory 4404 coupled with the processor 4402 may be configured to cause the NE 4400 to perform various functions (e.g., operations, signaling) described herein (e.g., executing, by the processor 4402, instructions stored in the memory 4404). In some implementations, the processor 4402 may include multiple processors and the memory 4404 may include multiple memories. One or more of the multiple processors may be coupled with one or more of the multiple memories, which may be individually or collectively, configured to perform various functions (e.g., operations, signaling) of the NE 4400 as described herein.

### NE Claim Support

The processor 4402 coupled with the memory 4404 may be configured to, capable of, or operable to cause the NE 4400 to transmit a SSB associated with a cell, where the SSB spans a plurality of symbols and comprises at least a first set of symbols and a second set of symbols mutually exclusive to the first set of symbols; transmit a broadcast channel (e.g., PBCH) within the first set of symbols; and transmit a reference signal (e.g., DMRS) corresponding to the broadcast channel within the second set of symbols, where one or more symbol locations of the second set of symbols is based at least in part on an identifier of the cell.

In some implementations, the SSB comprises a set of synchronization signals, the broadcast channel (e.g., PBCH), and the reference signal (e.g., DMRS). In such implementations, the set of synchronization signals may indicate the identifier of the cell.

In some implementations, the set of synchronization signals comprises a set of PSS and a set of SSS. In certain implementations, the set of PSS is offset from the set of SSS by at least one symbol of the first set of symbols or of the second set of symbols. In other words, there may be separation in the time-domain between the PSS and the SSS, such that there is at least a one symbol gap between the PSS and the SSS. Alternatively, the PSS and SSS may be located in adjacent symbols.

In some implementations, the reference signal (e.g., DMRS) is transmitted in one of two candidate symbol locations based at least in part on at least one bit associated with the identifier of the cell. In some examples, the symbol location of the reference signal (e.g., DMRS) is transmitted is based on a least significant bit (or the two least significant bits) of the cell identifier. In some implementations, the reference signal (e.g., DMRS) indicates a payload size of the broadcast channel (e.g., PBCH), or a coding rate associated with the broadcast channel, or both.

In some implementations, the cardinality (i.e., the number of elements in the set) of the first set of symbols is four, and the cardinality of the second set of symbols is one.

In some implementations, the first set of symbols (e.g., corresponding to the PBCH) comprises a first subset of symbols associated with a first payload (e.g., PBCH1) and a second subset of symbols associated with a second payload (e.g., PBCH2). In certain implementations, the first subset of symbols and the second subset of symbols are non-overlapping (e.g., the PBCH is split).

In certain implementations, the size of the first payload (e.g., PBCH1 size) is greater than the size of the second payload (e.g., PBCH2 size). In certain implementations, a coding rate associated with the first payload is higher than a coding rate associated with the second payload (e.g., PBCH2 is encoded with a lower coding rate than PBCH1).

In some implementations, the cell supports at least two types of UE (e.g., non-LPWA type UEs and LPWA type UEs). In such implementations, cell access information (e.g., PBCH payload) associated with a first type of UE (e.g., non-LPWA UE) is transmitted in the first subset of symbols and the second subset of symbols, and cell access information associated with a second type of UE (e.g., LPWA UE) is transmitted in the second subset of symbols (e.g., PBCH2). In other words, the LPWA type UEs may only need to decode the PBCH2. The cell access information refers to the PBCH payload used by a UE to access the cell, including one or more of the MIB, the PDCCH Config for SIB1, the SCS bit, the SSB Subcarrier Offset bits, and/or the dmrs-TypeA-Position bit. Because the PBCH content may vary for LPWA UEs and non-LPWA UEs, the PBCH payload may be split into two parts (e.g., PBCH1 and PBCH2).

In certain implementations, the reference signal (e.g., DMRS) is indicative of an order (e.g., arrangement) of the first subset of symbols (e.g., PBCH1) and the second subset of symbols (e.g., PBCH2) within the SSB. In other words, the arrangement indicated in the reference signal (e.g., DMRS) may specify: 1) which symbols belong to each subset, 2) a number of symbols in each subset, or both. In some examples, the reference signal (e.g., DMRS) is indicative of the time-domain locations of the first subset of symbols (e.g., PBCH1) and the second subset of symbols (e.g., PBCH2). In other words, the reference signal (e.g., DMRS) may indicate one or more symbol locations corresponding to the first subset of symbols (e.g., PBCH1) and one or more symbol locations corresponding to the second subset of symbols (e.g., PBCH2).

In certain implementations, the reference signal (e.g., DMRS) is associated with the first subset of symbols, or the second subset of symbols, or both. In some examples, the SSB comprises a split DMRS, where a first set of reference signals (e.g., PBCH1-DMRS) is associated with the first subset of symbols (e.g., PBCH1) and a second set of reference signals (e.g., PBCH2-DMRS) is associated with the second subset of symbols (e.g., PBCH2). In certain implementations, the first subset of symbols (e.g., PBCH1) occurs earlier in the time domain than the second subset of symbols (e.g., PBCH2).

In certain implementations, the broadcast channel (e.g., PBCH) comprises a subset of information provided in both the first subset of symbols (e.g., PBCH1) and the second subset of symbols (e.g., PBCH2). In other words, a portion of the information in PBCH1 is also in PBCH2 (i.e., same information).

The controller 4406 may manage input and output signals for the NE 4400. The controller 4406 may also manage peripherals not integrated into the NE 4400. In some implementations, the controller 4406 may utilize an operating system such as iOS®, ANDROID®, WINDOWS®, or other operating systems. In some implementations, the controller 4406 may be implemented as part of the processor 4402.

In some implementations, the NE 4400 may include at least one transceiver 4408. In some other implementations, the NE 4400 may have more than one transceiver 4408. The transceiver 4408 may represent a wireless transceiver. The transceiver 4408 may include one or more receiver chains 4410, one or more transmitter chains 4412, or a combination thereof.

A receiver chain 4410 may be configured to receive signals (e.g., control information, data, packets) over a wireless medium. For example, the receiver chain 4410 may include one or more antennas for receiving the signal over the air or wireless medium. The receiver chain 4410 may include at least one amplifier (e.g., a low-noise amplifier (LNA)) configured to amplify the received signal. The receiver chain 4410 may include at least one demodulator configured to demodulate the received signal and obtain the transmitted data by reversing the modulation technique applied during transmission of the signal. The receiver chain 4410 may include at least one decoder for decoding/processing the demodulated signal to receive the transmitted data.

A transmitter chain 4412 may be configured to generate and transmit signals (e.g., control information, data, packets). The transmitter chain 4412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 4412 may also include at least one power amplifier configured to amplify the modulated signal to an appropriate power level suitable for transmission over the wireless medium. The transmitter chain 4412 may also include one or more antennas for transmitting the amplified signal into the air or wireless medium.

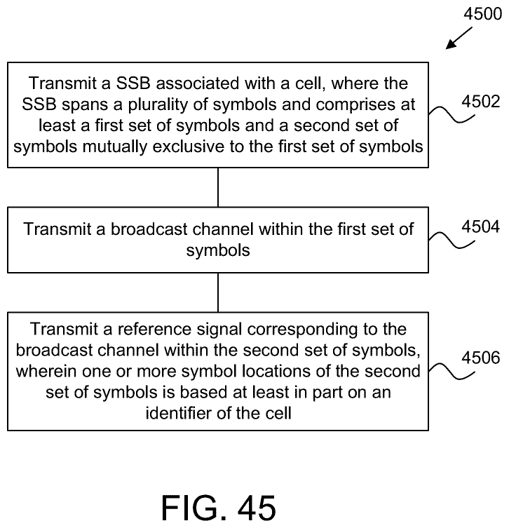

FIG. 45 illustrates a flowchart of a method 4500 in accordance with aspects of the present disclosure. The operations of the method 4500 may be implemented by a NE as described herein. In some implementations, the NE may execute a set of instructions to control the function elements of the NE to perform the described functions.

At step 4502, the method 4500 may include transmitting a SSB associated with a cell. Here, the SSB spans a plurality of symbols and comprises at least a first set of symbols and a second set of symbols mutually exclusive to the first set of symbols. The operations of step 4502 may be performed in accordance with examples as described herein. In some implementations, aspects of the operations of step 4502 may be performed by a NE, as described with reference to FIG. 44.

At step 4504, the method 4500 may include transmitting a broadcast channel within the first set of symbols. The operations of step 4504 may be performed in accordance with examples as described herein. In some implementations, aspects of the operations of step 4504 may be performed by a NE, as described with reference to FIG. 44.

At step 4506, the method 4500 may include transmitting a reference signal corresponding to the broadcast channel within the second set of symbols. Here, one or more symbol locations of the second set of symbols is based at least in part on an identifier of the cell. The operations of step 4506 may be performed in accordance with examples as described herein. In some implementations, aspects of the operations of step 4506 may be performed by a NE, as described with reference to FIG. 44.

It should be noted that the method 4500 described herein describes one possible implementation, and that the operations and the steps may be rearranged or otherwise modified and that other implementations are possible.

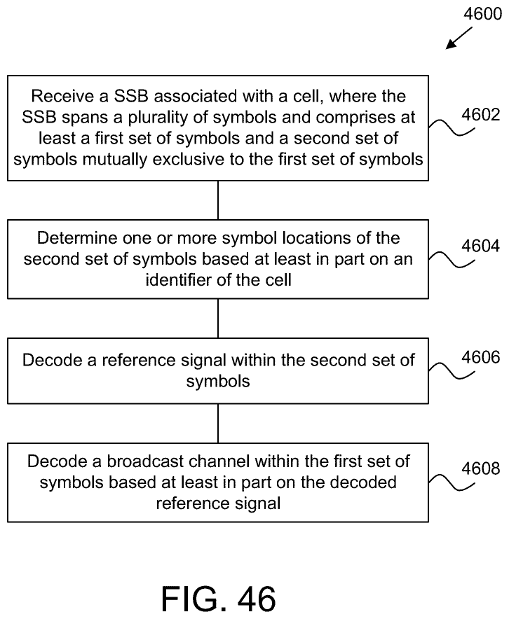

FIG. 46 illustrates a flowchart of a method 4600 in accordance with aspects of the present disclosure. The operations of the method 4600 may be implemented by a UE as described herein. In some implementations, the UE may execute a set of instructions to control the function elements of the UE to perform the described functions.

At step 4602, the method 4600 may include receiving a SSB associated with a cell. Here, the SSB spans a plurality of symbols and comprises at least a first set of symbols and a second set of symbols mutually exclusive to the first set of symbols. The operations of step 4602 may be performed in accordance with examples as described herein. In some implementations, aspects of the operations of step 4602 may be performed by a UE, as described with reference to FIG. 42.

At step 4604, the method 4600 may include determining one or more symbol locations of the second set of symbols based at least in part on an identifier of the cell. The operations of step 4604 may be performed in accordance with examples as described herein. In some implementations, aspects of the operations of step 4604 may be performed by a UE, as described with reference to FIG. 42.

At step 4606, the method 4600 may include decoding a reference signal within the second set of symbols. The operations of step 4606 may be performed in accordance with examples as described herein. In some implementations, aspects of the operations of step 4606 may be performed by a UE, as described with reference to FIG. 42.

At step 4608, the method 4600 may include decoding a broadcast channel within the first set of symbols based at least in part on the decoded reference signal. The operations of step 4608 may be performed in accordance with examples as described herein. In some implementations, aspects of the operations of step 4608 may be performed by a UE, as described with reference to FIG. 42.

It should be noted that the method 4600 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station for wireless communication, comprising:
at least one memory; and
at least one processor coupled with the at least one memory and configured to cause the base station to:
transmit a synchronization signal block (SSB)associated with a cell, wherein the SSB spans a plurality of symbols and comprises at least a first set of symbols and a second set of symbols mutually exclusive to the first set of symbols;
transmit a broadcast channel within the first set of symbols; and
transmit a reference signal corresponding to the broadcast channel within the second set of symbols, wherein one or more symbol locations of the second set of symbols is based at least in part on an identifier of the cell.

2. The base station of claim 1, wherein the SSB comprises a set of synchronization signals, the broadcast channel, and the reference signal, and wherein the set of synchronization signals indicates the identifier of the cell.

3. The base station of claim 2, wherein the set of synchronization signals comprises a set of primary synchronization signals (PSS) and a set of secondary synchronization signals (SSS), and wherein the set of PSS is offset from the set of SSS by at least one symbol of the first set of symbols or the second set of symbols.

4. The base station of claim 1, wherein the reference signal is transmitted in one of two candidate symbol locations based at least in part on at least one bit associated with the identifier of the cell.

5. The base station of claim 1, wherein the reference signal indicates a payload size of the broadcast channel, or a coding rate associated with the broadcast channel, or both.

6. The base station of claim 1, wherein a cardinality of the first set of symbols is four, and wherein a cardinality of the second set of symbols is one.

7. The base station of claim 1, wherein the first set of symbols comprises a first subset of symbols associated with a first payload and a second subset of symbols associated with a second payload, and wherein the first subset of symbols and the second subset of symbols are non-overlapping.

8. The base station of claim 7, wherein a size of the first payload is greater than a size of the second payload, or wherein a coding rate associated with the first payload is higher than a coding rate associated with the second payload.

9. The base station of claim 8, wherein the cell supports at least two types of user equipment (UE), wherein cell access information associated with a first type of UE is transmitted in the first subset of symbols and the second subset of symbols, and wherein cell access information associated with a second type of UE is transmitted in the second subset of symbols.

10. The base station of claim 7, wherein the reference signal is indicative of an order of the first subset of symbols and the second subset of symbols within the SSB.

11. The base station of claim 7, wherein the reference signal is associated with the first subset of symbols or a second set of reference signals associated with the second subset of symbols, or both.

12. The base station of claim 7, wherein the broadcast channel comprises a subset of information transmitted in the first subset of symbols and the second subset of symbols.

13. The base station of claim 7, wherein the first subset of symbols occurs earlier in a time domain than the second subset of symbols.

14. A method performed by a base station, the method comprising:
transmitting a synchronization signal block (SSB) associated with a cell, wherein the SSB spans a plurality of symbols and comprises at least a first set of symbols and a second set of symbols mutually exclusive to the first set of symbols;
transmitting a broadcast channel within the first set of symbols; and
transmitting a reference signal corresponding to the broadcast channel within the second set of symbols, wherein one or more symbol locations of the second set of symbols is based at least in part on an identifier of the cell.

15. A user equipment (UE) for wireless communication, comprising:
at least one memory; and
at least one processor coupled with the at least one memory and configured to cause the UE to:
receive a synchronization signal block (SSB) associated with a cell, wherein the SSB spans a plurality of symbols and comprises at least a first set of symbols and a second set of symbols mutually exclusive to the first set of symbols;
determine one or more symbol locations of the second set of symbols based at least in part on an identifier of the cell;
decode a reference signal within the second set of symbols; and
decode a broadcast channel within the first set of symbols based at least in part on the decoded reference signal.

16. The UE of claim 15, wherein the at least one processor is configured to cause the UE to:
detect a set of synchronization signals based at least in part on the received SSB, wherein the received SSB comprises the set of synchronization signals, the broadcast channel, and the reference signal; and
determine at least a portion of the identifier of the cell based at least in part on the detected set of synchronization signals.

17. The UE of claim 15, wherein the first set of symbols comprises a first subset of symbols associated with a first payload and a second subset of symbols associated with a second payload, and wherein the at least one processor is configured to cause the UE to:
receive an indication to decode the first subset of symbols, or the second subset of symbols, or both, based at least in part on a type of the UE,
wherein the first subset of symbols and the second subset of symbols are non-overlapping.

18. The UE of claim 15, wherein, to decode the broadcast channel, the at least one processor is configured to cause the UE to:
determine a time reference based at least in part on the SSB;
select one or more symbols for decoding the broadcast channel based at least in part on the time reference; and
decode the broadcast channel based at least in part on the selected one or more symbols.

19. The UE of claim 18, wherein the time reference comprises a system frame number (SFN), and wherein the one or more symbols for decoding the broadcast channel is selected based at least in part on the SFN.

20. A method performed by a user equipment (UE), the method comprising:
receiving a synchronization signal block (SSB) associated with a cell, wherein the SSB spans a plurality of symbols and comprises at least a first set of symbols and a second set of symbols mutually exclusive to the first set of symbols;
determining one or more symbol locations of the second set of symbols based at least in part on an identifier of the cell;
decoding a reference signal within the second set of symbols; and
decoding a broadcast channel within the first set of symbols based at least in part on the decoded reference signal.
